(19) United States
(12) Patent Application Publication
(10) Pub. No.: US 2026/0178893 A1
(43) Pub. Date: Jun. 25, 2026

(54) Skin-Like Stretchable Neuromorphic Devices for Artificial Intelligence Applications

(71) Applicant: The University of Chicago, Chicago, IL (US)

(72) Inventors: Sihong Wang, Chicago, IL (US); Yahao Dai, Chicago, IL (US); Shilei Dai, Chicago, IL (US)

(73) Assignee: The University of Chicago, Chicago, IL (US)

(21) Appl. No.: 18/712,942

(22) PCT Filed: Nov. 18, 2022
(86) PCT No.: PCT/US2022/050455

§ 371 Date: May 23, 2024

Related U.S. Application Data
(60) Provisional application No. 63/282,859, filed on Nov. 24, 2021.
(60) Provisional application No. 63/359,039, filed on Jul. 7, 2022.

(51) Int. Cl. G06N 3/063; G06N 3/04; G06N 3/08

(52) U.S. Cl. CPC G06N 3/063; G06N 3/04; G06N 3/08

(57) ABSTRACT

This disclosure generally relates to neuromorphic computing devices, systems, and platforms for artificial intelligence applications. Specifically, the disclosed platform is stretchable, and devices fabricated based on such a platform can thus be configured to adhere to human skin conformably even in areas of the skin that frequently stretch, bend, or otherwise deform. The devices may be integrated to form a wearable and stretchable artificial neural network (ANN) circuit for performing predictive health monitoring and other functions. For example, each neuron of the ANN may be based on a neuromorphic organic-electrochemical-transistor (OECT) structure and each OECT structure may be based on a redox-active electrochemical cell. The ANN can be trained and updated as the device is being worn on human body. The electronic characteristics relevant the neuromorphic computation of the ANN may be minimally impacted by repeated stretching of the device.

### CROSS REFERENCES

This application is based on and claims the benefit of priority to U.S. Provisional Patent Application No. 63/282,859, filed on Nov. 24, 2021, and U.S. Provisional Patent Application No. 63/359,039 filed on Jul. 7, 2022, which are herein incorporated by reference in their entireties.

### GOVERNMENT LICENSE RIGHTS

This invention was made with government support under grant number N00014-21-1-2266 and N00014-21-1-2581 awarded by the U.S. Office of Naval Research and grant number 2011854 awarded by U.S. National Science Foundation. The government has certain rights in the invention.

### BACKGROUND

A wearable electronic device attached to human skin may be fabricated using stretchable materials to provide comfort by increasing conformity of the device to skin deformation and movement. Such devices, for example, may be configured to sense and collect health-related data. It is further desirable to using these devices for in-situ computation based on the collected health-related data. Such computation may vary in complexity. It is critical that the sensing and computational functions of these devices are not materially affected by a manner and extend in which they are stretched.

### SUMMARY

This disclosure generally relates to neuromorphic computing devices, systems, and platforms for artificial intelligence applications. Specifically, the disclosed platform is stretchable, and devices fabricated based on such a platform can thus be configured to adhere to human skin conformably even in areas of the skin that frequently stretch, bend, or otherwise deform. The devices may be integrated to form a wearable and stretchable artificial neural network (ANN) circuit for performing predictive health monitoring and other functions. For example, each neuron of the ANN may be based on a neuromorphic organic-electrochemical-transistor (OECT) structure and each OECT structure may be based on a redox-active electrochemical cell. The ANN can be trained and updated as the device is being worn on human body. The electronic characteristics relevant the neuromorphic computation of the ANN may be minimally impacted by repeated stretching of the device.

In some implementations, a wearable device is disclosed. The wearable device includes a stretchable substrate; a stretchable capping layer; and a stretchable artificial neural network (ANN) circuitry integrated between the stretchable substrate and the stretchable capping layer. The ANN circuitry may include interconnecting artificial neurons, wherein each artificial neuron comprises at least one stretchable organo-electrochemical transistor (OECT). Each OECT may include a gate electrode; a semiconducting layer, the semiconducting layer being redox-active; a source electrode and a drain electrode in electrical contact with the semiconducting layer; a dielectric layer disposed between the gate electrode and the semiconducting layer, the dielectric layer being of an electrolyte-type; and an electrical channel through the semiconducting layer from the source electrode to the drain electrode, the electrical channel being characterized by a plurality of conductance states to enable neuromorphic computation in the ANN circuitry. The gate electrode, the semiconducting layer, the source electrode, the drain electrode, and the dielectric layer are stretchable.

In some other implementations, another wearable device is disclosed. The variable device includes a stretchable substrate; a stretchable capping layer; and a stretchable artificial neural network (ANN) circuitry integrated between the stretchable substrate and the stretchable capping layer, the stretchable ANN circuitry comprising interconnecting artificial neurons comprising organo-electrochemical cells. The stretchable ANN circuitry is configured to implement a neuromorphic artificial intelligence computing algorithm

### BRIEF DESCRIPTION OF THE DRAWINGS

The system and method may be better understood with reference to the following drawings and description. Non-limiting and non-exhaustive embodiments are described with reference to these drawings. The components in the drawings are not necessarily to scale, with emphasis instead being placed upon illustrating the general underlying principles of the various disclosed embodiments.

FIG. 1 illustrates an example skin-like wearable device containing an artificial neural network (ANN) implemented using neuromorphic computation principles and trained for on-skin health monitoring.

FIG. 2 illustrates an example organic-electrochemical-transistor structure.

FIG. 3 illustrates an example material composition of the organic-electrochemical-transistor structure of FIG. 2.

FIG. 4 illustrates an example stretchable semiconducting material that can be used to form a conducting channel in the example organic-electrochemical-transistor structure of FIG. 2.

FIG. 5 illustrates an example stretchable organo-hydro-gel that can be used as part of the electrochemical cell in the example organic-electrochemical-transistor structure of FIG. 2.

FIG. 6 illustrates a cross-sectional view of the example organic-electrochemical-transistor structure of FIG. 3 showing the underlying principles of electrochemical operation.

FIG. 7 illustrates optical and atomic-force-microscopy (AFM) images of an example p(gT2) semiconducting film.

FIG. 8 shows OECT transfer function measurements of an example stretchable semiconducting film under various stretching conditions.

FIG. 9 shows normalized channel conductance and mobility measurements of an example OECT device under various stretching conductions.

FIG. 10 shows grazing-incidence X-ray diffraction (GIXD) measurement of an example p(gT2) film under 0 and 100% strain conditions.

FIG. 11 shows conductance states of an example OECT device as controlled and written by gate potentiation pulses.

FIG. 12 further shows examples of the multiple conductance states of the OECT device of FIG. 11.

FIG. 13 shows long-term longevity of two example conductance state of the OECT device after being written.

FIGS. 14-15 show controlling or writing conductance states of an example OECT device vial gate pulses in potentiation and depression cycles.

FIG. 16 illustrates effect of parallel strain (to the channel direction) on conductance states of an example OECT device in one potentiation and depression cycle.

FIG. 17 illustrates effect of cyclic stretching perpendicular to the channel direction on the conductance states of an example OECT device in one potentiation and depression cycle.

FIG. 18 shows extracted nonlinearity and symmetricity index in the conductance states of an example OECT device under various strain conditions.

FIG. 19 shows extracted nonlinearity and symmetricity index in the conductance states of an example OECT device over multiple stretching cycles.

FIG. 20 shows measured conductance invariance over 50 potentiation and depression cycles in an example OECT device under 0 strain.

FIG. 21 shows measured conductance invariance over 50 potentiation and depression cycles in an example OECT device under 100% strain.

FIGS. 22-25 illustrate accumulative distribution function (CDF) heat map of an example OECT device showing extracted distribution of change of conductance in potentiation and depression process, and for 0 strain and for 100% strain.

FIG. 26 illustrates a schematic for an example array of OECT devices being connected by writing lines and reading lines.

FIG. 27 illustrates a schematic for vector-matrix-multiplication (VMM) in an artificial neural network.

FIG. 28 shows an example device having a 3-by-3 array of OECT devices.

FIG. 29 shows an example for implementing VMM, where the matrix being multiplied is written into the neural network.

FIGS. 30-31 illustrate a comparison between calculated and measured VMM multiplication results of an example 3-by-3 OECT array.

FIG. 32 shows an example 1-layer convolutional neural network (CNN) for electrocardiogram (ECG) classification.

FIGS. 33-34 show simulated accuracy of the 1-layer OECT CNN for ECG classification of FIG. 32 based on characteristics of measured OECT devices under various parallel and perpendicular strain conditions.

FIGS. 35-38 illustrate confusion matrices for various ECG classifications of ECG patterns at different strain levels.

FIG. 39 illustrates an example p(gT2) polymerization reaction.

FIG. 40 illustrates a gel permeation chromatography (GPC) measurement of an example p(gT2) in dimethylformamide (DMF).

FIG. 41 shows an example procedure for growing a stretchable Au nanowire electrode.

FIG. 42 illustrates an example procedure for fabricating an array of stretchable electrode.

FIG. 43 illustrates an example process for patterning organo-hydro-gel.

FIG. 44 shows an optical image of an array of stretchable electrode.

FIG. 45 illustrates optical images of an example vertical gold nanowire electrode on PMMA/silicon substrate patterned with PET tape-based mask before pouring PDMS and after the PDMS is cured.

FIG. 46 illustrates optical images of an example vertical gold nanowire electrode embedded in PDMS after being peeled off from PMMA/Silicon wafer under different strain levels.

FIG. 47 shows quantification of stretchability of an example vertical gold nanowire electrode in terms of sheet resistance at different stretching conditions and after multiple stretching cycles.

FIG. 48 shows an example process for preparing a p(gT2) film into different strain conditions for measurements.

FIG. 49 shows optical images of unstretched and 100% stretched Ag/AgCl paste-based electrode.

FIG. 50 shows sheet resistance of the example Ag/AgCl paste-based electrode of FIG. 49 under different strain conditions and after multiple stretching cycles.

FIG. 51 shows optical images and stress-strain relation of an example organo-hydro-gel.

FIG. 52 shows measured transient response of an example OECT device manufactured using p(gT2) under application of a constant gate current and under different strain conditions.

FIG. 53 shows measured volumetric capacitance and threshold voltage of an example p(gT2) film under different stretching conditions.

FIG. 54 illustrates polarized optical microscopy images of an example p(gT2) film under different strain directions showing polymer alignment as a result of strain.

FIG. 55 shows polarized UV-visible spectra and dichroic ratio of an example p(gT2) film under different strain conditions.

FIG. 56 shows in-plane and out-of-plane line X-ray scattering analysis of an example p(gT2) film under different strain conditions.

FIGS. 57-58 illustrate nonlinearity of conduction states in potentiation and depression processes of an example OECT device.

FIGS. 59-60 illustrate asymmetry of conduction states in potentiation and depression processes of an example OECT device.

FIG. 61 shows producibility of change of conductance upon weight update in an example OECT device in different conductance states during 50 potentiation and depression cycles under 0 or 100% strain.

FIG. 62 illustrates an example 2-layer perceptron network for hand-written digit recognition.

FIG. 63 illustrates simulated accuracy of a 2-layer perceptron network for hand-written digit implemented as an array of OECT devices under different strain conditions.

FIG. 64 illustrates an example long-short-term-memory (LSTM) network.

FIG. 65 illustrates simulated accuracy of the LSTM network based on an array of OECT devices under different strain conditions.

FIG. 66 illustrates ECG classification simulation results based on LSTM as visualized by 5-by-5 confusion matrices for comparing inferred and target ECG classes.

FIGS. 67-70 illustrate long-term storage stability of an example OECT-based neuromorphic device.

### DETAILED DESCRIPTION

### Introduction

By way of introduction, special types of skin-like and stretchable materials may be engineered and designed to host and enable sensors, actuators, and electronic circuit components. These components may be further integrated into stretchable electronic devices and systems. These devices and systems may be utilized in various applications. For example, they may form artificial electronic skin for robots and the like. For another example, these devices may be implemented as a special type of wearable electronics. Unlike other types of wearable devices such as watches, bracelets, and the like, these stretchable devices may be implemented to seamlessly adhere to human skin. The ability for these electronic devices to conformally stretch with human skin under normal skin deformation and movement may help improve comfort and provide wider adaptability of these devices to areas of skin that deform/stretch more frequently and to a larger extent than other areas.

Such stretchable, skin-like, and wearable electronic devices, with its sensing, actuation, and signal processing functionalities, may be configured to assist in personalized precision medicine and other applications. For example, these stretchable and wearable electronic devices may be adapted to continuously sense, acquire, collect, receive, and/or otherwise obtain, during long-term daily activities outside of clinics, high-fidelity multi-modal data including but not limited to real-time health-related measurements (such as heart rate, blood pressure, pulses, exercises, calories burned, sleep data, and the like) and environmental data (such atmospheric temperature, humidity, barometric information, air quality, and the like). Such data, in combination with personal information (such as gender, age, ethnicity, personal health history, family health history, and the like), may be used to continuously derive/predict/infer individualized heath metrics, health patterns, diagnosis, and/or treatment information which takes into consideration the underlying differences in personal genes, ages, health histories, and living environments. In other words, a form of automatic and intelligent precision health monitoring, precision medicine, or precision healthcare may be implemented relying at least partly on these stretchable and wearable electronic devices.

The processing of the multi-modal data above in order to recognize the underlying personalized health patterns and diagnostics may be generally characterized by relatively high-throughput and intelligent analytics of complicated and large-quantity of diverse datasets. In some implementation, such data processing and analytics may utilize artificial intelligence (AI) computation. Such AI computation may generally involve training (alternatively referred to as “learning”), generation, and execution of one or more AI models. An example of an AI model may include one or more artificial neural networks (ANNs) in various forms. An ANN may be implemented as interconnecting artificial neurons. Such artificial neurons and ANN formed thereof may emulate information/signal propagation and processing in biological neural networks. An ANN may be trained and then used to process a set of input data such as the health-related measurement data, environmental data, and personal information described above to generate/derive health conditions, diagnostics and/or treatment information.

In some practical circumstances, it may be desired that the multi-modal data above be processed in situ (e.g., next to the data acquisition sites/sensors) in order to minimize the need for wireless or long-distance data transfer that typically comes with the problems of latency, insecurity, and extra power consumption. As such, in some implementations, the ANNs may be integrated into and as part of wearable electronic devices. Consequently, the circuitry that is configured to perform the ANNs within the sin-like wearable device platform and designed with the same stretchable and skin-like mechanical properties while including all necessary electronic components may be relatively high in circuitry density and may not be operationally affected by mechanical stretching or deformation with the skin.

Such artificial neurons and ANNs, for example, may be implemented using traditional digital circuits based on binary field-effect-transistors (FETs) for logic operations and memory cells for storage of model parameters. The implementation of AANs using such traditional digital circuits may be limited to conventional architecture based on von Neuman computing.

Alternatively, such artificial neurons and ANNs may be implemented using a neuromorphic computing architecture that provides multi-state analog-like (rather than binary) computing units or neurons and which mimics brain operation and thus provides a more natural and more efficient platform for implementing the training and operation of an ANN. Such computing architecture, when employed to implement the ANN, may offer lower system complexity, lower energy consumption, and other advantages over the van Neuman architecture.

In this disclosure, a suite of material and device design strategies are implemented to achieve intrinsically stretchable neuromorphic devices based on an example organic-electrochemical-transistor (OECT) architecture. The various layers of materials in these OECT devices are all designed in stretchable form. The example OECT device provides a large number (>800) of distinct stable and long-lived conductance or memory states which can be controlled through electric writing lines with low switching variations. When used for constructing an ANN circuit, the conductance states of the OECT may be used to represent weight parameters of the ANN. The control of the conductance states thus effectively provides weight updates. The weight updates of in these ample OECT devices are highly linear and symmetric with low switching variations, and exhibit excellent switching endurance (>108), good state retention (>104 s), all under high stretchability of 100% strain and over 100 repeated stretching cycles. Further integration of the example OECT devices into an example array is successfully implemented to perform a vector-matrix multiplication (VMM) as an example core analog-computing function even at 100% strain. In addition, an AI-based classification of health signals (e.g., electrocardiograms) may be implemented using an example OECT-based ANN with a high accuracy and minimal influence from the stretched state of the neuromorphic OECT hardware underlying the ANN.

### Example Stretchable Organic Electrochemical Transistors

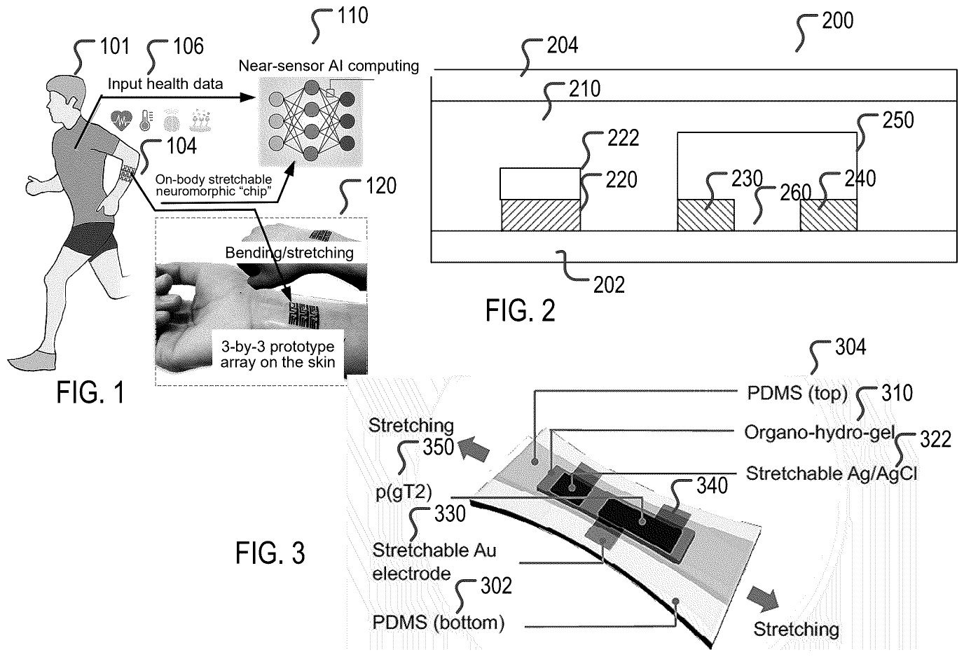

FIG. 1 illustrates an example implementation of a stretchable and skin-like wearable devices integrated with one or more ANNs. In particular, one or more wearable electronic devices 104 may adhere to human skin. The wearable electronic devices may be stretchable and conform to the human skin to allow for comfortable deformation, bending, and stretching of the human skin, as shown by 120. Their electronic functionalities may be minimally affected or unaffected by the stretching. Such example wearable electronic devices may be embedded with electronic circuits for implementing one or more AI model containing one or more ANNs shown as 110 with the circles representing various artificial neurons and the lines therebetween representing connections among the artificial neurons. As illustrated in the ANN 110 of FIG. 1, these artificial neurons, for example, may be arranged in layers. The connection between the neurons may be configured across the layers.

The input data to the ANN 106 may include but are not limited to health-related, environmental, and personal data as shown in 106. Some of these data may be collected continuously and in real-time. For example, health-related data such as heartrate, pulses, body temperature, blood pressure, and the like may be collected in real-time, at any updating time scale, by sensor circuitry embedded in the wearable electronic devices or separate from but in communication with the wearable electronic devices 104.

In some example implementations, electronic hardware components for implementing the wearable neuromorphic computing architecture may be base on, for example, phase-change memory, atom switch devices, memristors, and electrolyte-gated transistor. Each of these types of components carry different mechanical and electronic characteristics and therefore may be suitable for different applications. For the ANN processing of health data with time-variant nature and the training of the corresponding ANNs, as described above, the wearable neuromorphic devices may combine stretchability with a multitude of performance characteristics, including but not limited to (1) a wide range of linear and symmetric ANN weight updates, (2) sufficient state-retention time (e.g., >1000 s) for learning and inference and for holding the ANN weights and other parameters, (3) sufficient write endurance, (4) low variation in weight update, and (5) a large number of separable and analog-like memory states. The term “weight” as used above represents ANN signal propagation coefficients or parameters from neuron to neuron. Such weights represent model parameters and are determined via training or learning process of the ANN. The large number of memory states (rather than binary states) provide the key physical property that enables the efficient ANN computation using such neuromorphic circuits.

In some example implementations, organic electrochemical transistors (OECTs) may be implemented as basic functional blocks, neurons, or components for neuromorphic computing. In some implementations, such OECTs may be designed to provide the stretchability while maintaining stable and consistent electronic and neuromorphic computing functionalities. Each OECT structure may contain materials across various types, including, for example, semiconductors, conductors, and dielectrics. As such, all these types of materials implemented as part of OECTs may need to be engineered to be stretchable with suitable, stable, and nearly strain-invariant electronic properties.

FIG. 2 shows a cross-section of an example stretchable OECT structure or device 200. The OECT device 200 may include encapsulating layers 204 and 202 for sandwiching the active layers of the OECT device 200. The actively layer of the OECT device 200 may include, for example, a semiconducting gate electrode 222 in contact with a gate contact electrode 220, and semiconducting source and drain electrodes 230 and 240 (S/D). A modulable/controllable conducting channel 260 may be formed between the source and drain electrodes 230 and 240 within a doped semiconducting layer 250. The gate electrode 222 is coupled to the doped semiconducting layer 250 via a dielectric layer 210. A voltage applied to the gate electrode 222 via the gate contact electrode 220 relative to, e.g., a voltage applied to the source electrode 230, may be capable of controlling the carrier density of the doped semiconductor layer 250 and the conductance of the conducting channel between the source and drain electrodes 230 and 240. For neuromorphic information storage and computation, the conductance of the channel may be configured to be finely controlled by the gate-source voltage, yielding a multitude of and analog-like conductance states in this OECT device 200 between the source electrode 230 and the drain electrode 240.

Each of the material layers, either conducting, semiconducting, dielectric, or encapsulating layers is designed to be stretchable, yielding the entire OECT structure stretchable. Furthermore, the electronic properties, including the operation of the OECT device, under various gate, source, and drain voltages may be configured to be minimally impacted when the OECT structure is stretched.

The OECT structure 200 in FIG. 2 is illustrated merely as an example. While the example OECT structure is implemented as an extended-gate structure, other OECT structures can also be implemented in alternative suitable geometries. For example, the lateral shapes and sizes of the various layers may not be limited in any manner. For another example, the semiconducting gate electrode 222 and the gate contact electrode 220 need not match in size as long as they are in sufficient electric contact. For yet another example, the gate electrode 222 and the gate contact electrode 220 need not be lateral to the source and drain semiconducting layer 250. In some implementations, they may be stacked along the growth direction (perpendicular to the layers in FIG. 2). Furthermore, while the example OECT structure 200 of FIG. 2 is illustrated as a single transistor, an array of these transistors may be connected, e.g., in-plane or vertically stacked, as a circuit, as described in further detail below, to implemented an ANN.

The operation of organic electrochemical transistors such as the one illustrated in FIG. 2 may be based on continuous and non-volatile electrochemical doping of polymer semiconductors (e.g., semiconductor layer 250 of FIG. 2). Such structure may be engineered to provide all the aforementioned performance characteristics for neuromorphic commutation and neuromorphic ANN, and at the same time be stretchable with respect to the material layers across the board (including semiconductors, conductors, and dielectrics) with suitable electric properties for OECT functions.

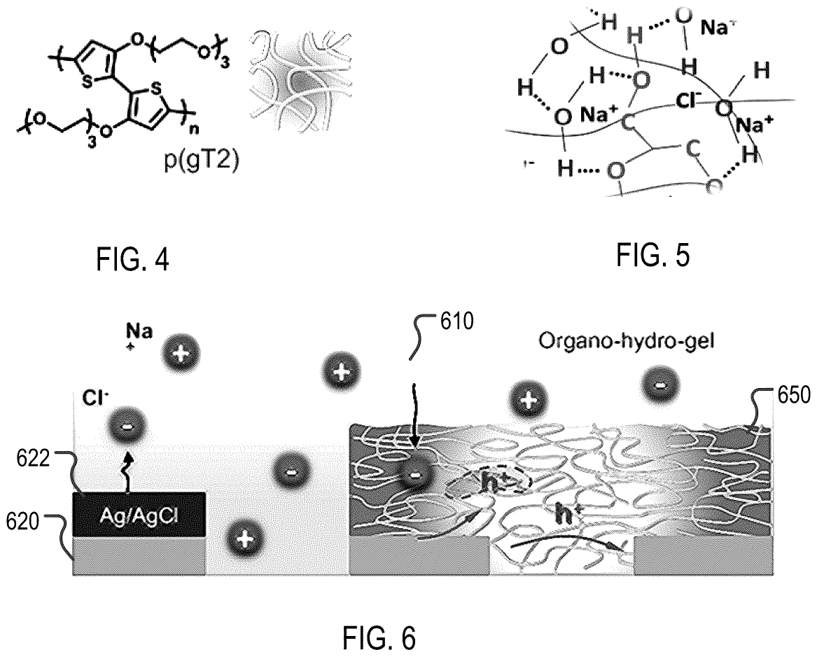

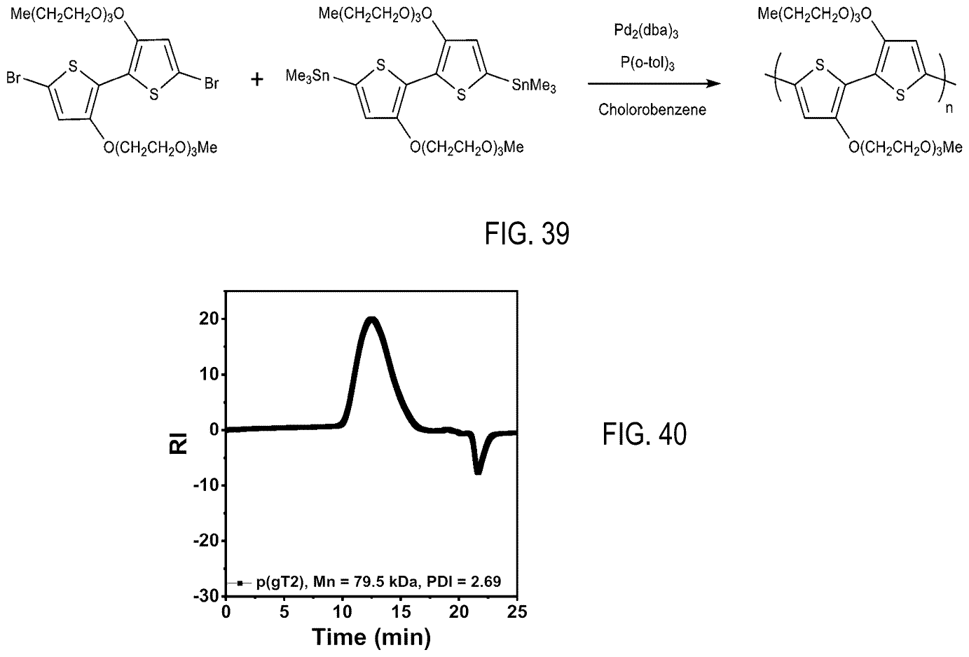

FIG. 3 further illustrates a specific example implementation of the stretchable OECT device 200 of FIG. 2. The semiconducting layer 250 of FIG. 2, for example, may be implemented use a redox-active semiconducting polymer, as shown by 350. Such redox-active semiconducting polymer, merely as an example, may be based on a polythiophene backbone and tri-ethylene-glycol (TEG) side chain, e.g., poly-[3,3′-bis(2-(2-(2-methoxyethoxy) ethoxy) ethoxy)-2,2′-bithiophene] (or p(gT2)), with an example molecular form shown in FIG. 4. Such redox-active semiconductor polymer may offer stretchability of, e.g., 100% strain. Its synthesis, polymerization, and characteristics are described in further detail below in this disclosure in relation to FIG. 39 and FIG. 40.

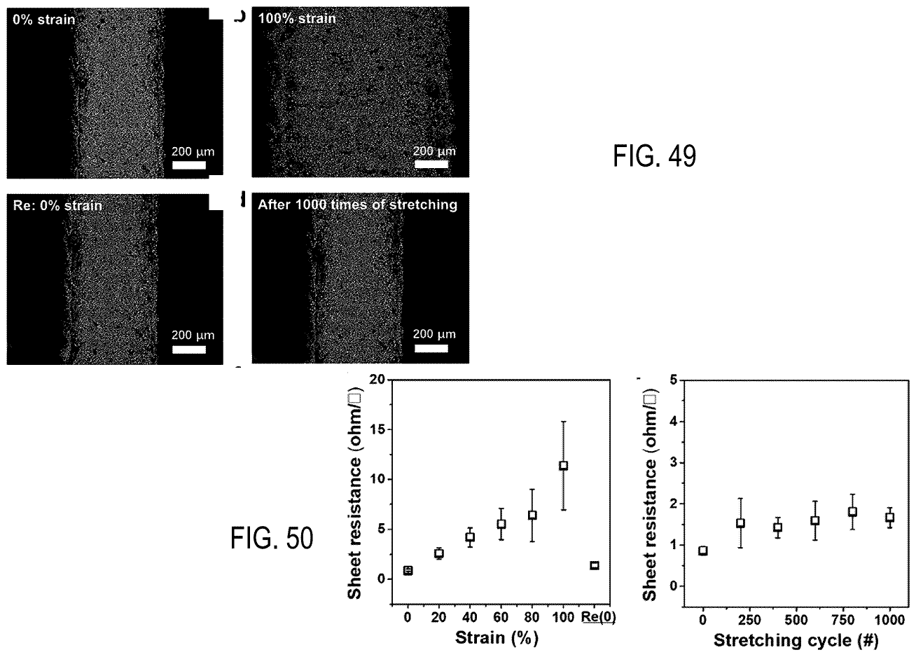

As also shown in FIG. 3, an Ag/AgCl paste gate electrode 322 may be used as the redox-active gate electrode 222 of FIG. 2 with stretchability of 100% strain. Its physical properties are further illustrated in FIG. 49 and FIG. 50. For example, the upper right and upper left panels of FIG. 49 illustrate optical image of the Ag/AgCl electrode under 0 strain and 100% strain, respectively, showing no cracks and material uniformity under stretching. Further, the lower left and lower right panels show that, after, e.g., 1000 stretching cycles, the Ag/AgCl electrode still maintains its original physical and mechanical shape and size. Such a gate electrode may function as a reference electrode for providing a stable gating potential. As further shown in FIG. 50, the sheet resistance of the example Ag/AgCl electrode increases slightly to about 10 ohm/(ohm/square) under stretching and the sheet resistance is minimally affected by repeated stretching cycles. The sheet resistance recovers once the strain is released.

As further shown in FIG. 3, the dielectric layer 210 of FIG. 2 for the OECT device may be implemented as an electrolyte-type dielectric layer that can form a continuous ion-transport pathway between the semiconductor layer 350 and gate electrode 322. The stretchability with 100% strain may be realized in the dielectric layer, for example, by creating a hybrid organo-hydro-gel, based on a polyacrylamide (PAAm) network swelled by a water-glycerol binary solvent, as shown in FIG. 5. NaCl (or other salt) may be further added inside the gel and it can be solvated by water and may penetrate the semiconductor 350 layer to dope the polymer semiconductor, as also shown in FIG. 5. Glycerol, which can form strong hydrogen bonding with water, for example, may be added to achieve the long-term stability of the gel dielectric by preventing dehydration and lowering its freezing point. Further details of example composition and fabrication of the hybrid organo-hydro-gel are described below in relation to Section “Example Materials and Synthesis”.

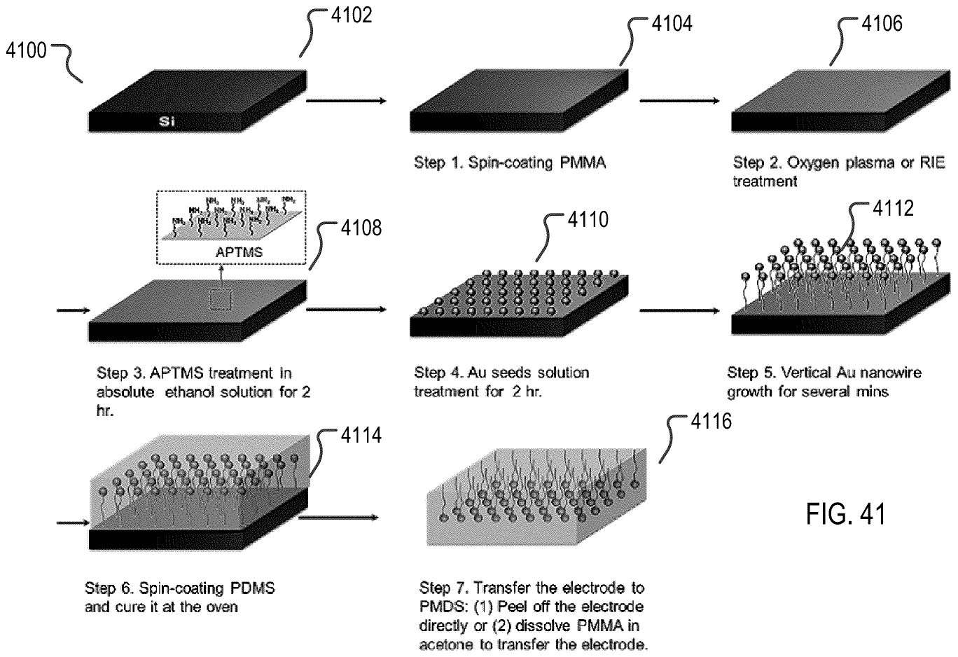

In addition, the stretchable source and drain electrodes (230 and 240 of FIG. 3) shown as 330 and 340 in FIG. 3 in the example OECT devices may be designed to possess electrochemical stability and high conductivity, which precludes the commonly used options of stretchable conductors made from carbon-nanotube assemblies, Ag nanowire assemblies, liquid metal, stretchable PEDOT, or PSS. For example, the stability and conduction properties may be achieved via a unique stretchable design for Au. For a specific example, the S/G electrodes may be implemented as vertically-grown-nanowire-array embedded in, e.g., substrate 302, which, for example, may be formed using PDMS, thereby providing the high stretchability through PDMS while maintaining its conductance. Further details with respect to such Au nanowires are provided below in this disclosure in relation to FIGS. 41, 42, 44, 45-46. Such example S/G electrodes may be stretched to 100% strain while maintaining a low sheet resistance of, for example, ˜30Ω/□, as illustrated by FIG. 47 showing that the sheet resistance of the S/D electrodes is minimally affected by stretching cycles (4702 shows the sheet resistance as a function strain, and 4704 shows that sheet resistance invariance as a function of the number of stretching cycles).

The example OECT devices built by the above set of materials may enable redox reactions between the p(gT2) semiconductinglayer 350 and the Ag/AgCl gate electrode 322, providing analog (multi-level or multi-state) and non-volatile modulation of the conductance in the channel within the p(gT2) semiconductor layer between the source and drain 330 and 340, as shown in FIG. 6. Specifically, a redox reaction, or an oxidation-reduction reaction refers to a type of chemical reaction that involves a transfer of electrons between two specifies of materials. An oxidation-reduction reaction may refer to any chemical reaction in which the oxidation number of a molecule, atom, or ion changes by gaining or losing an electron. In the example of FIG. 6, the redox reaction, or transfer of electrons between the Ag/AgCl gate 622 and the semiconducting layer 650 via the organo-hydro-gel 610 with NaCl may be controlled by a voltage applied between the gate contact electrode 620 and the source. For example, one polarity of gate voltage may add carriers and thus increase channel conductance whereas the opposite gate voltage may remove carriers and thus decrease the channel conductance. The integrated gate-source voltage over time determines the number of carriers doped into the semiconducting layer 650 and thus determine the conductance state of the channel between the source and drain. The S/D conductance thus may be controlled by gate-source voltage pulses. Each voltage pulse may be characterized by its polarity, amplitude, and time duration. The pulse area (gate voltage amplitude integrated over the time duration) determines carrier added or removed. A gate-source voltage pulse in a first polarity that adds carriers may be referred to as a potentiation pulse whereas a gate-source voltage pulse in the opposite polarity may be referred to as a depression pulse. The effect of multiple gate pulses may be accumulative in the example device of FIG. 6 as long as the electro-chemical cell of the device is capable of maintaining the carrier levels (in other words, conductance state of the device) in the absence of any gate-source voltage. In the implementations throughout this disclosure, the gate voltage may be used to update the conductance state of the device based on FIG. 6 and the various analog-like conductance states represents ANN model parameters such as weights.

This example stretchable device may be used as a basic building block to enable the example skin-like stretchable neuromorphic “chip” described in 120 of FIG. 1 that can adhere to human skin and function with human body with deformable and conformable properties.

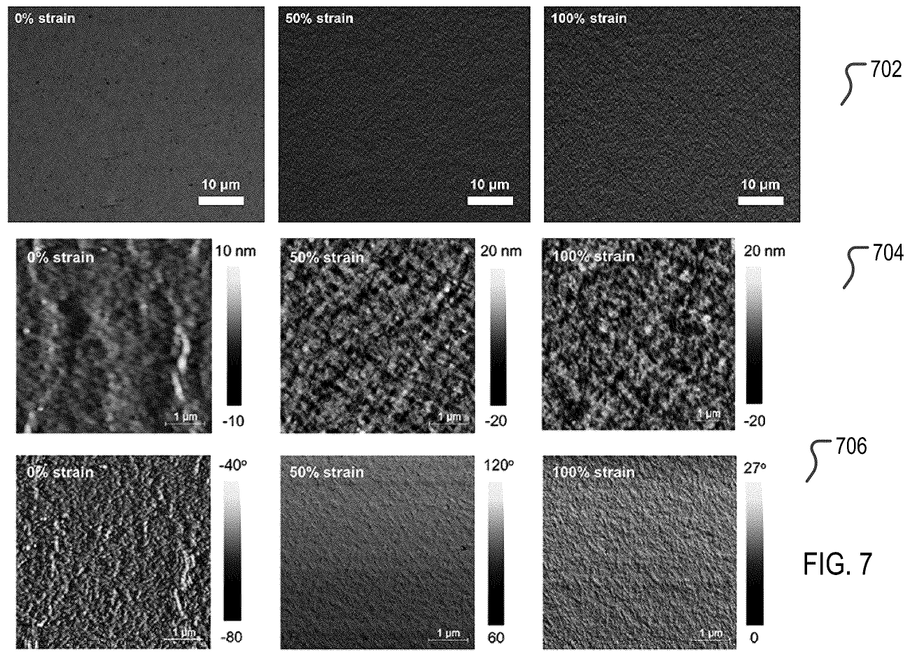

The semiconducting layer 350 constitutes a critical component for both the high stretchability and computing performance of the neuromorphic device based on the example OECT structures above. FIG. 7 shows optical microscopy, atomic force microcopy height, and atomic force microcopy phase images in 702, 704, and 706, respectively, of the example p(gT2) under 0-100% strain. FIG. 7 shows that the example p(gT2) film can be stretched to from 0 to 100% strain without any appreciable cracks, as a result of the relatively flexible polythiophene backbone. The term “100% strain” is used to refer to a stretching factor of 2 in a given stretching direction.

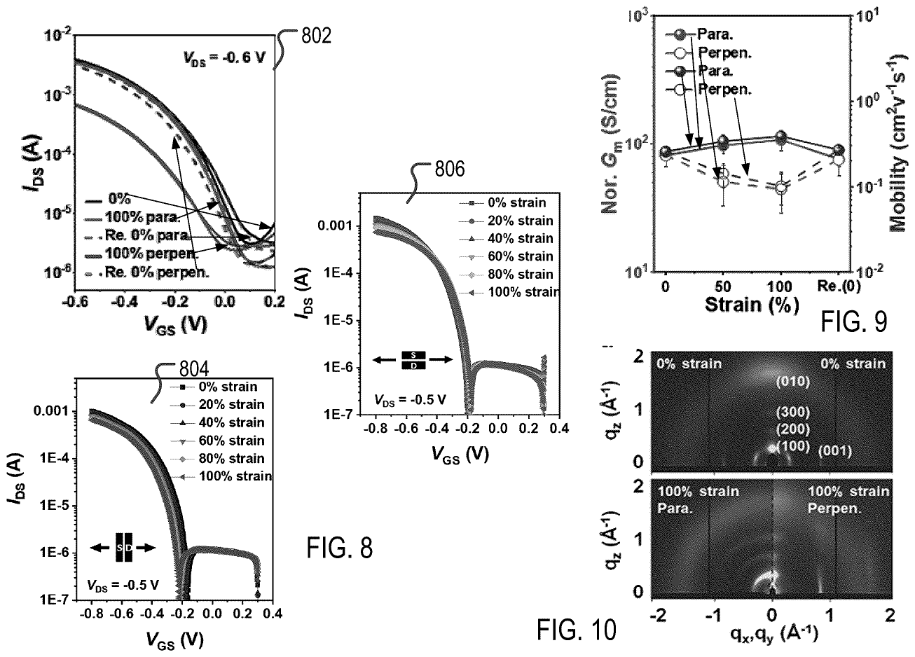

In some implementations, a transfer-lamination method may be used to measure or determine the OECT electric performance or behavior of the p(gT2) film under different strains. For example, FIGS. 8 and 9 respectively show a comparison of electric transfer curve and normalized transconductance and mobility obtained from an example p(gT2) film in its original and various stretched states as a function of the gate-source voltage under an example drain-source voltage of 0.6 volt. Specifically, FIG. 8 shows the D/S current as a function of gate-source voltage in logarithm scale for different strain conditions and with different substrates (rigid for 802 and fully flexible for 804 and 806). FIG. 9 shows the normalized conductance and mobility of the OECT device as a function of strain. In FIG. 8 and FIG. 9, the measurements start with a non-stressed film and the film is then stretched to various strain levels and in either the parallel direction or perpendicular direction relative to the S/D channel direction. The strain in the film is then released. Measurements of the transfer curve, the normalized transconductance, and the mobility of the film are conducted in each original, strained, and strain-released configuration. The label “Re” represents strain-released condition.

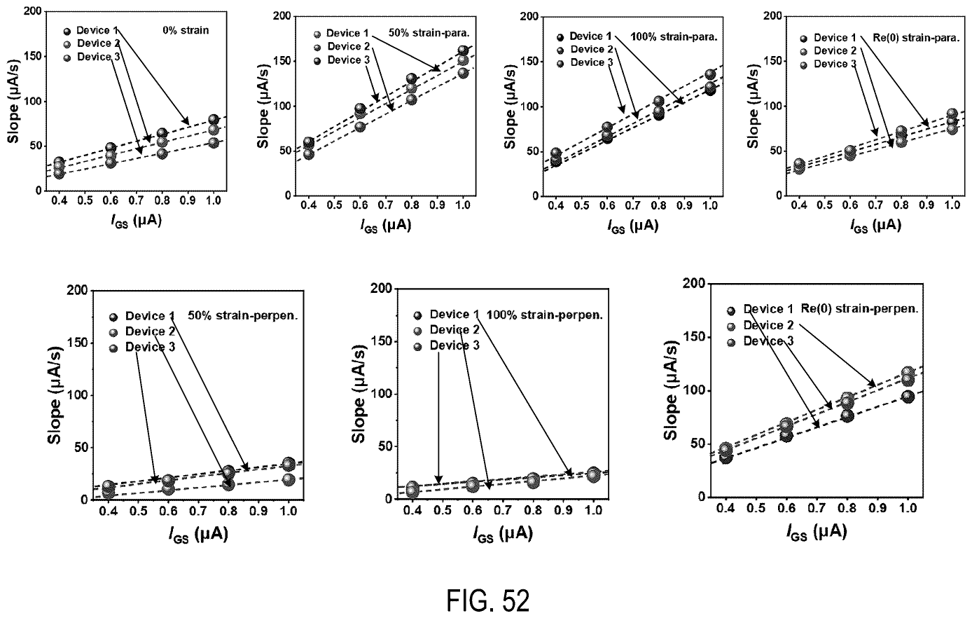

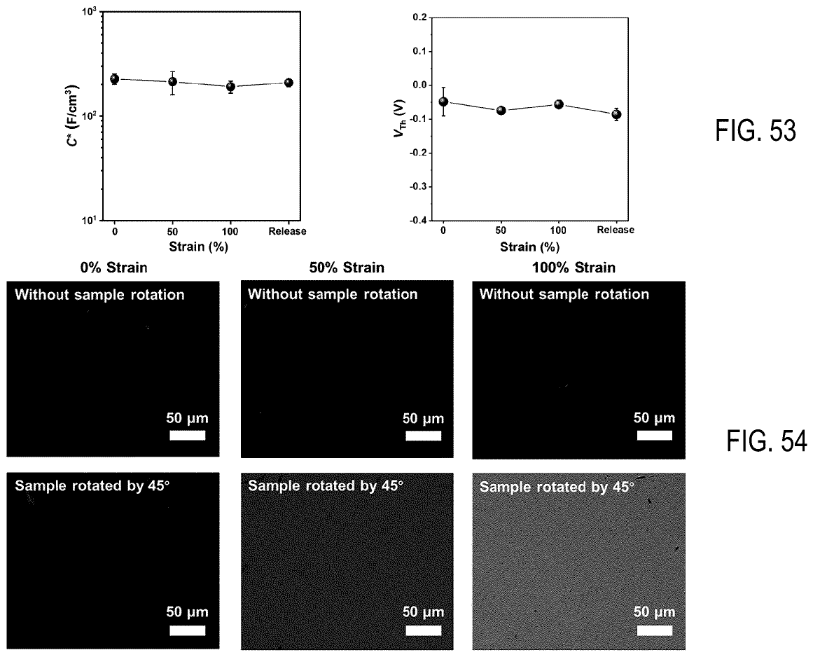

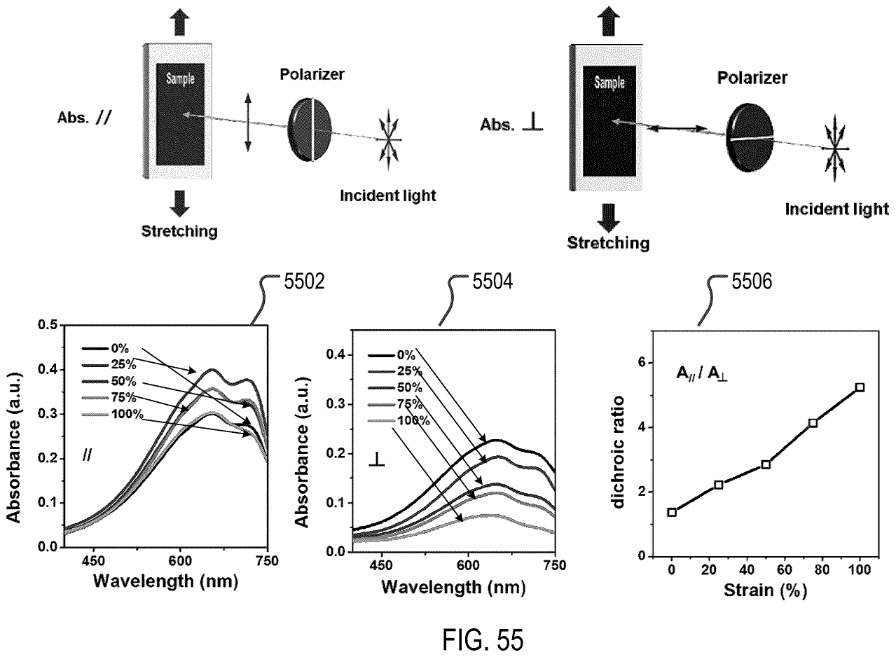

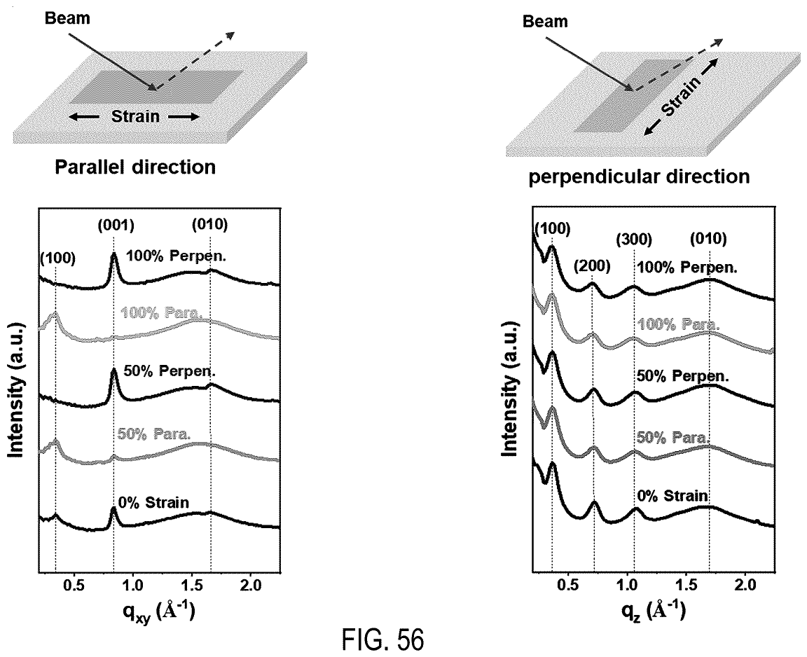

FIGS. 8 and 9 show that, starting from an un-strained OECT performance with an on/off ratio over 10³ as a function of the gate voltage and a normalized transconductance (Gₘ) of (81±14) S/cm, the stretching processes in directions parallel and perpendicular to the channel-length direction lead to only a slight increase, and a slight decrease in Gₘ, respectively. Upon releasing to 0% strain, the Gₘ mostly reverts to the original value. This observed trend is consistent with the changes of the mobility under these stretching processes with the volumetric capacitance (C*) and the threshold voltage (V_{Th}) remaining stable, as further described below in relation to FIG. 52 and FIG. 53. Such observed anisotropic response to stretching mainly comes from the strain-induced chain alignment on this highly stretchable polymer, as suggested and confirmed by (1) cross-polarized optical microscopy images as described in more detail below in relation to FIG. 54, (2) an increase of the dichroic ratio from polarized UV-vis spectroscopy as described in further detail below in relation to FIGS. 55, and (3) a change in grazing-incidence X-ray diffraction (GIXD) with incident beams in parallel and perpendicular to the strain as shown in FIG. 10 and as described in further detail below in relation to FIG. 56. The GIXD results in FIG. 10 with the detail explanation below in relation to FIG. 56 show moderate crystallinity of the p(gT2) polymer, which may serve as a morphological basis for the high stretchability. A strain-induced change of mixed face-on and edge-on packing to edge-on-dominated packing is also observed.

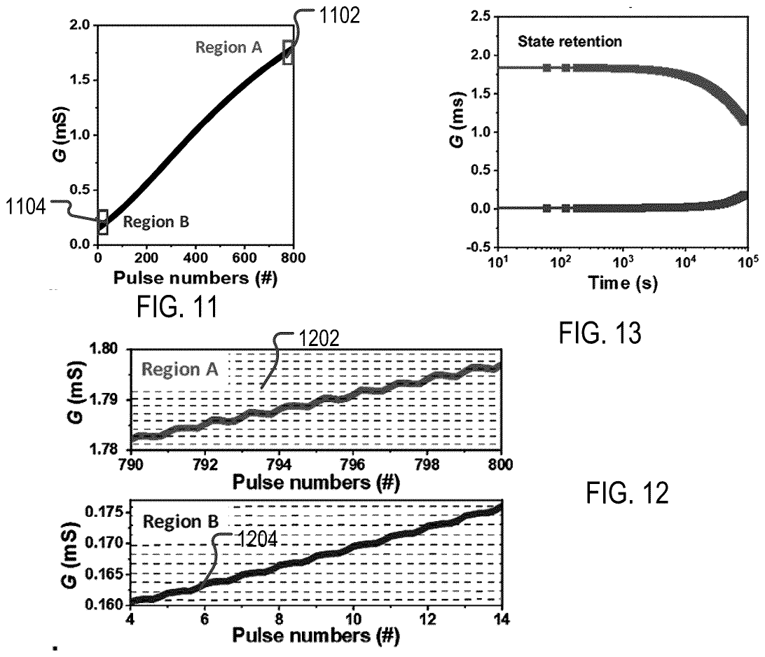

In some implementations, and as descried above the gate electrode of the OECT device above may be driven in predefined voltage pulses (between the gate electrode and the source) to control the redox reaction and the carrier doping in channel. Each of the pulse may induce some amount of change in the doping of the semiconducting layer 250, 350, or 650 of FIG. 2, 3 or 6, thereby modifying the channel conductance G. The number of pulses may determine a channel conductance, and thus a channel state. As described above, a gate-source voltage pulse may be a potentiation pulse or a depression pulse. In FIG. 11, device conductance G measured on an example OECT device under an optimized pulse condition is shown as a function of the number of gate pulses applied. As further shown in 1202 and 1204 of FIG. 12, corresponding to two graphed regions 1102 and 1104 of FIG. 11, a large number of conductance states are available. In the particular example of FIGS. 11 and 12, as high as 800 distinct conductance states may be obtained as a function of the number of gate-source voltage pulses, providing the multiple analog-like conductance states needed for neuromorphic computing.

Performances of the OECT device above that are critical to stretchable neuromorphic commutating may include, for example, its ability to perform analog weight update and retain its state. As mentioned above, the analog weight update may be performed based on gate-source voltage pulses that constitutes a writing process in neuromorphic computing. As shown by FIGS. 11 and 12, the example OECT device above displays a large number of distinct analog conductance states that may be used for weight updates or the neuromorphic writing. Such example characteristics is likely a result of a high volumetric capacitance of the p(gT2) semiconductor at around 227±26 F/cm³ in the OECT device above. Following the weight update or writing process, the retention for any potentiated and depressed analog-like conductance states in the “reading” condition may be desired. In the reading condition, the source and gate electrodes may be disconnected.

The conductance state retention characteristics of the OECT device after writing may be further measured. FIG. 13 shows that the conductance state retention time may be as high as over 10,000 seconds, sufficient for application requiring on-device training of ANN. FIG. 13 specifically shows measured evolution of conductance for the full potentiated state (upper curve) and the fully depressed state (lower curve) as a function of time when the source and gate electrodes are disconnected (under the reading condition) after a writing process. When the “reading” period is further increased beyond 105 seconds, the accumulated decay of the conductance states as shown in FIG. 13 may be originated from self-discharging behaviors of any type of electrochemical cells.

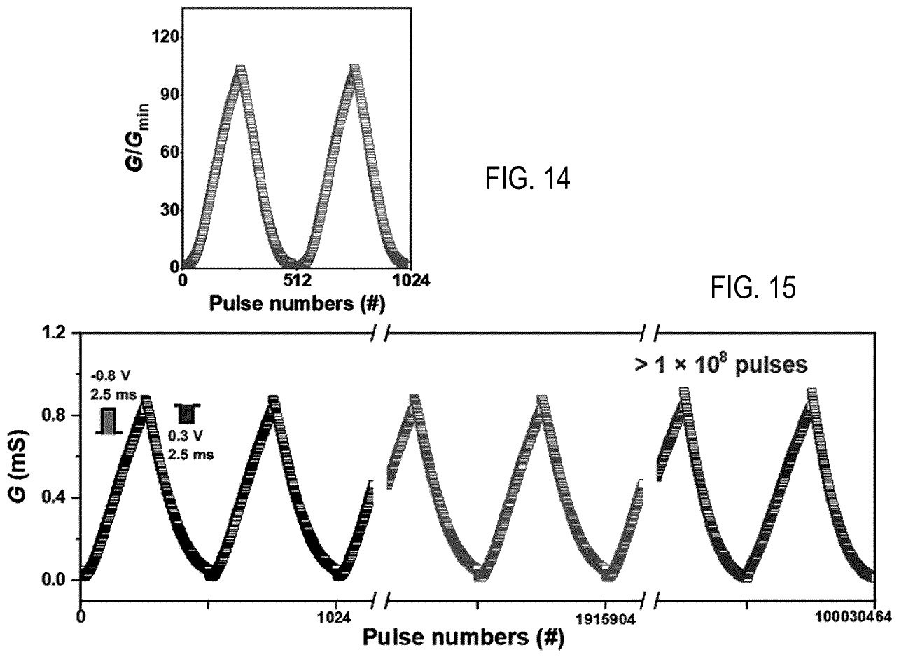

FIG. 14 shows device conductance (G) of long-term potentiation-depression (LTP-LTD) cycles as a function of gate-source voltage pulse numbers in unstretched condition. Specifically, a dynamic range (Gₘₐₓ/Gₘᵢₙ) value for conductance greater than 100 is achieved in the OECT device above under an optimized pulse condition (i.e., V_{LTP} and V_{LTD}). Furthermore, as another critical characteristic for efficient online or on-device training of ANN in neuromorphic computing, a high linearity and symmetricity may also be obtained from the example OECT device above at the same time, as shown in FIG. 14. Further, the switching endurance of the OECT device above may be measured, shown in FIG. 15 as the measured device conductance in unstretched condition as a function of number of gate-source voltage pulses. Specifically, more than 108 pulses are applied during repeated LTP-LTD cycles, and no significant degradation of the device performance are observed. FIG. 15 shows consistent maximum conductance and stable linearity. The OECT device with PDMS packaging further exhibits on-shelf stability of more than 4 months.

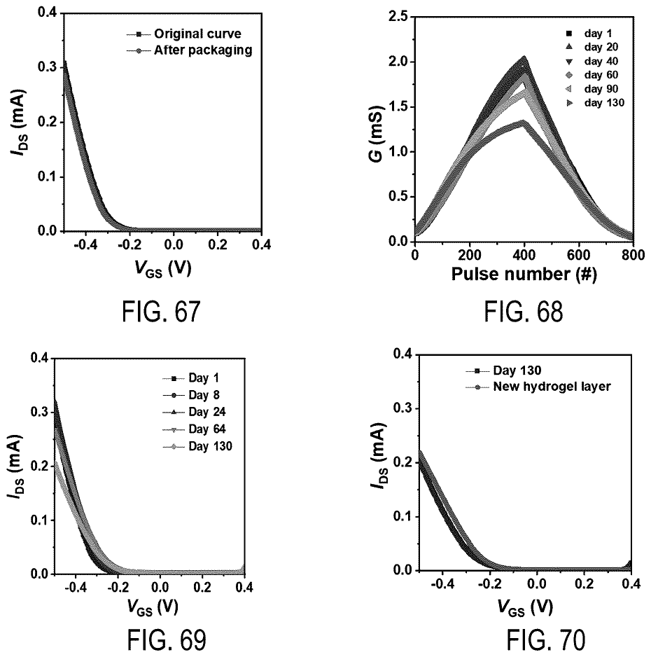

For example, FIG. 67 particularly illustrates a comparison between an original transfer curve of an OECT device as fabricated and a corresponding transfer curve after packaging, showing minimal change in output current as a function of the gate-source voltage. FIG. 68 shows conductance measurement during an LTP and LTD cycle for the example OECT device as a function of shelf time. FIG. 69 shows the transfer curve as a function of shelf days. FIG. 70 shows a comparison of the transfer curves for the example OECT device as fabricated and the OECT device without the organo-hydro-gel layer as manufactured but fit with a new organo-hydro-gel layer after 130 days. FIG. 13 and FIGS. 67-70 are shown to illustrates the robustness of the electric performance of the example OECT devices relevant to intended neuromorphic computation.

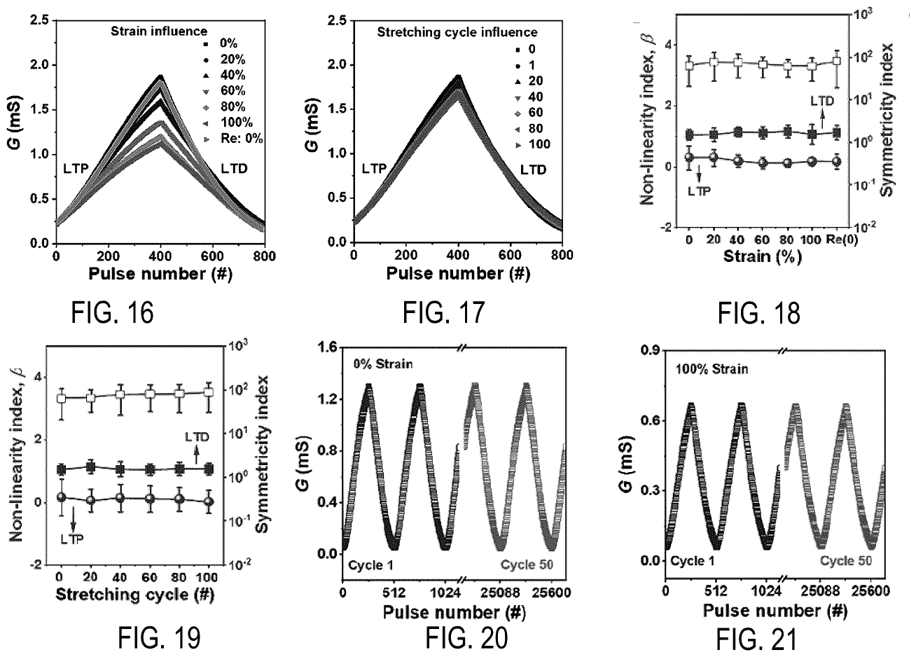

The electronic functionality of the OECT devices above under stretching is further characterized by measuring the LTP-LTD cycles when the OECT device is stretched stepwise from 0 to 100% strain and then released, in both parallel and perpendicular directions to the channels. FIG. 16 shows conductance as a function of pulse numbers in one LTP-LTD cycle for various parallel stretching. FIG. 16 shows that the strain causes a moderate decrease of the conductance level of each updated weight (pulse number). The decrease may be attributed to a combined effect of the device's geometry change and the strain-induced chain alignment in the semiconducting layer as described above. Upon releasing to 0% strain, these changes are mostly reversible. FIG. 17 shows device conductance as a function of gate-source voltage pulse number between continuous stretching cycles. FIG. 17 shows that 100 cycles of stretching to 100% strain caused negligible changes to the LTP-LTD performance. As shown by FIGS. 16 and 17, high degree of linearity and symmetricity is well maintained during these stretching processes.

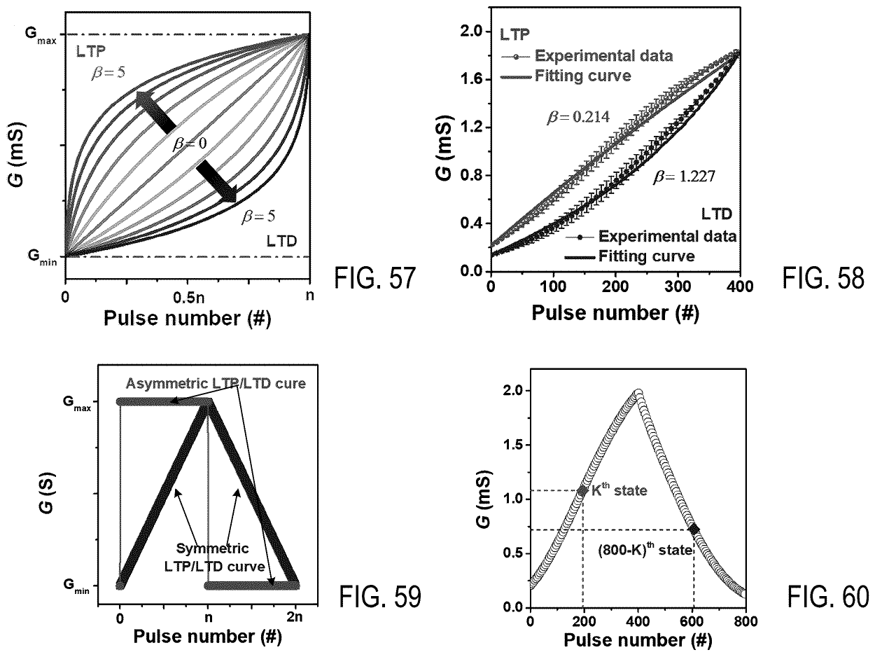

The linearity may be quantitatively analyzed using two example extracted parameters, e.g., a nonlinearity index β and a symmetricity index with more details provided below in relation to FIGS. 57-60. FIG. 18 shows example extracted nonlinearity index β (left axis) and symmetricity index (right axis) under different strain levels. As shown in FIG. 18, the stretching leads to minimal changes to the initial β around 0.2 and 1.2 for LTP and LTD, indicating high linearity. FIG. 18 further shows little change in the high initial symmetricity index of around 70. FIG. 19 further shows that the nonlinearity index and the symmetricity index of the OECT device are largely unaffected by the stretching cycles. Further details for the linearity analysis are provided below in relation to FIGS. 57-60. In addition, the conductance state retention of the OECT devices above at 100% strain is largely unaltered. These behaviors indicate the example OECT device's well-maintained capability for implementing ANN computation under large strains.

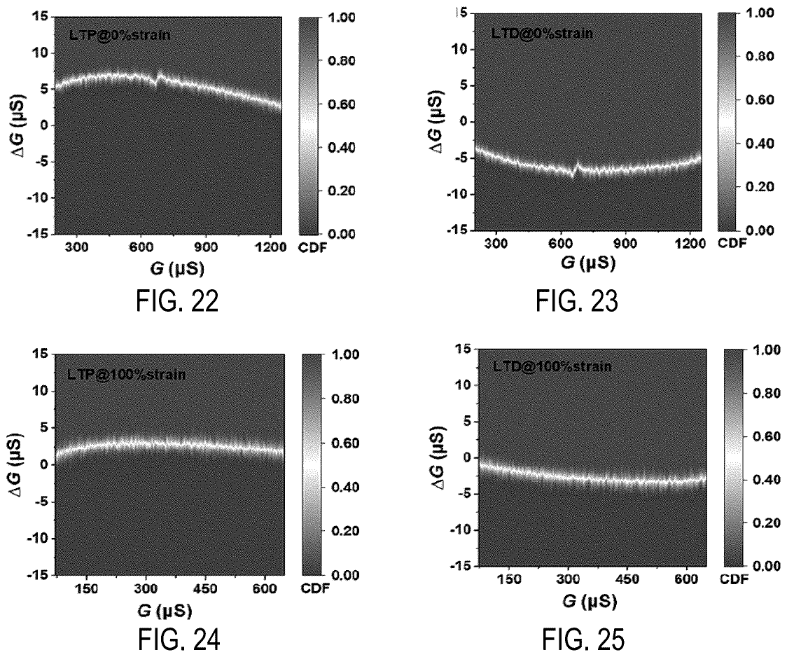

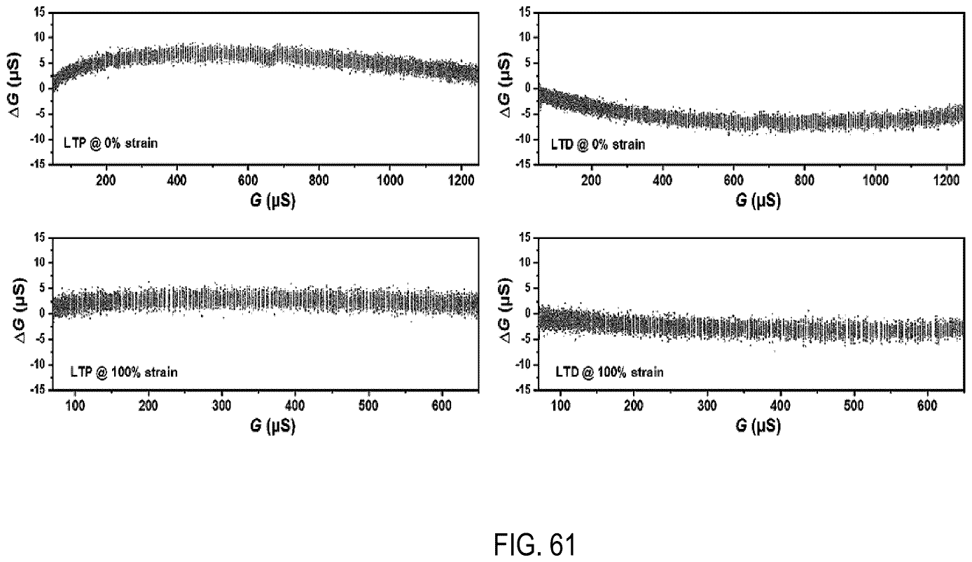

FIG. 20 and FIG. 21 further show a comparison of measured device conductance (G) from repeated LTP-LTD cycles under 0 and 100% strain, respectively, as a function of number of gate-source voltage pulses. For simplicity only, the first LTP-LTD cycle and the 50th LTP-LTD cycle are shown. The change of conductance under every additional gate pulse (ΔG) may be extracted for each of the multiple conductance state (represented by G) during the 50 LTP-LTD cycles. Such single-pulse weight updates may be further analyzed using the cumulative distribution function (CDF):

$${CDF}_{G} ( Δ {G}_{x} ) = {\int }_{− 15}^{Δ {G}_{x}} {p}_{G} ( Δ G ) d Δ {G}_{x}$$

where p_{G}(ΔG) is the probability distribution for ΔG under a certain conductance state G. As shown by the heat plots of CDF for the ΔG distribution in FIGS. 22-25, the OECT devices above maintain a high linearity and repeatability (i.e., low weight update distribution) under both unstretched and stretched conditions. FIG. 61 further shows the change in conductance upon a weight update, with every pulse under different channel conductance states, during 50 LTP-LTD cycles. Each dot represents one weight update value in FIG. 61.

### OECT Array and Vector-Multiplication

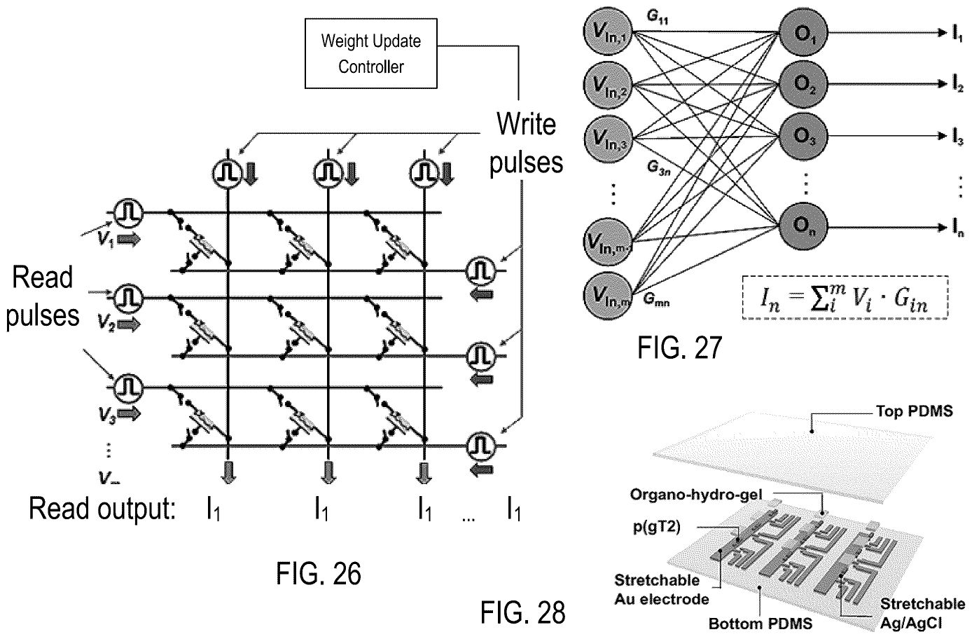

The example OECT devices above may be integrated into an array to perform an ANN capable of performing, for example, vector-multiplication (VMM) as one of the basic computational steps in most ANN algorithms. FIG. 26 shows an example array of integrated OECT devices cable of carrying out VMM operations illustrated in FIG. 27. An example 3-by-3 OECT array is shown in FIG. 28. In some implementations, the array of FIG. 28 may be fabricated by patterning all the components: the p(gT2) semiconductor, the organo-hydrogel, the stretchable Au nanowire electrodes, and the stretchable Ag/AgCl reference gate. Further details pertaining an example fabrication and patterning procedure is further illustrated below in relation to the section “Example Procedure for Fabrication of Neuromorphic Device Array.” While the OECT devices may be arranged in any number and any configuration, the example of FIG. 28 contains 9 (3 rows by 3 columns) neuromorphic OECT devices. The source electrodes from the three neuromorphic OECT devices in each row are connected as three output lines, as shown by the three thick traces across the array in FIG. 28. The write pulses for weight updates may be applied between the gate and source lines as shown in FIG. 26. The weight update and writing process may be controlled by a weight update controller shown in FIG. 26.

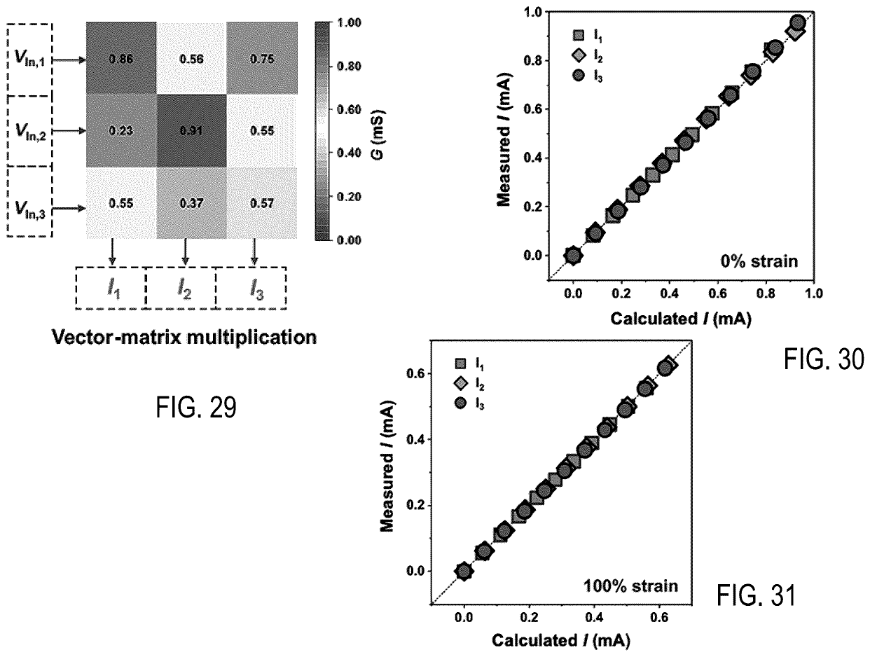

The measured LTP-LTD cycles from each of the 9 OECT devices in the array all show similar performances. To demonstrate VMM operations, a random set of conductance states {Gij} may be written and mapped into the 9 OECT devices in the array by the write pulses, as shown in FIG. 29. In {Gij}, the index i and j represent the row and column indices, and G represents a randomly chosen value of the conductance state that can be written into the OECT devices of the array. Then, different sets of input voltage signals, (V_{ln,1}, V_{ln,2}, V_{ln,3}) of FIG. 28 or (V₁, V₂, V₃) of FIG. 29, may be applied to the three input lines of the array. According to Kirchhoff's law, the three output currents should be the inner product between the input voltage vector and the conductance matrix, as

$${I}_{j} = {\sum }_{i = 1}^{3} {V}_{i} \cdot {G}_{i j}$$

FIGS. 30 and 31 show measured output current and calculated output current according to the Kirchhoff's law above under both 0 and 100% strain conditions. Further details between a comparison between the measurements and calculation is listed below.

TABLE 1

| | | | | | | | | | | | |
|---|---|---|---|---|---|---|---|---|---|---|---|
| | V [symbol] (V) | 0.050 | 0.100 | 0.150 | 0.200 | 0.250 | 0.300 | 0.350 | 0.400 | 0.450 | 0.500 |
| | V [symbol] (V) | 0.050 | 0.100 | 0.150 | 0.200 | 0.250 | 0.300 | 0.350 | 0.400 | 0.450 | 0.500 |
| | V [symbol] (V) | 0.050 | 0.100 | 0.150 | 0.200 | 0.250 | 0.300 | 0.350 | 0.400 | 0.450 | 0.500 |
| 0% strain | Calculated I₁ (mA) | 0.082 | 0.165 | 0.247 | 0.329 | 0.412 | 0.494 | 0.576 | 0.659 | 0.741 | 0.823 |
| | Calculated I₂ (mA) | 0.092 | 0.184 | 0.276 | 0.369 | 0.461 | 0.553 | 0.645 | 0.737 | 0.829 | 0.921 |
| | Calculated I₃ (mA) | 0.093 | 0.186 | 0.280 | 0.373 | 0.466 | 0.559 | 0.652 | 0.745 | 0.839 | 0.932 |
| | Measure I₁ (mA) | 0.082 | 0.164 | 0.248 | 0.330 | 0.414 | 0.496 | 0.83 | 0.669 | 0.754 | 0.844 |
| | Measure I₂ (mA) | 0.096 | 0.190 | 0.286 | 0.379 | 0.471 | 0.562 | 0.654 | 0.740 | 0.834 | 0.920 |
| | Measure I₃ (mA) | 0.091 | 0.183 | 0.281 | 0.371 | 0.465 | 0.563 | 0.659 | 0.756 | 0.854 | 0.956 |
| 100% strain | Calculated I₁ (mA) | 0.056 | 0.112 | 0.168 | 0.224 | 0.280 | 0.336 | 0.392 | 0.448 | 0.504 | 0.560 |
| | Calculated I₂ (mA) | 0.063 | 0.125 | 0.188 | 0.251 | 6.314 | 0.376 | 0.439 | 0.502 | 0.565 | 0.627 |
| | Calculated I₃ (mA) | 0.062 | 0.123 | 0.185 | 0.247 | 0.309 | 0.370 | 0.432 | 0.494 | 0.556 | 0.617 |
| | Measure I₁ (mA) | 0.055 | 0.111 | 0.166 | 0.223 | 0.278 | 0.334 | 0.300 | 0.445 | 0.500 | 0.556 |
| | Measure I₂ (mA) | 0.062 | 0.124 | 0.187 | 0.250 | 0.313 | 0.312 | 0.438 | 0.500 | 0.564 | 0.626 |
| | Measure I₃ (mA) | 0.061 | 0.122 | 0.183 | 0.245 | 0.306 | 0.367 | 0.420 | 0.491 | 0.554 | 0.616 |

[symbol]

indicates data missing or illegible when filed

FIG. 30, FIG. 31 and the table above illustrate that the measured output current I for each set of input voltage signals is consistent with the calculated value from the above multiplication equation, under both 0 and 100% strain on the array, showing that the stretchable neuromorphic array is capable of implementing VMM-based ANN algorithms, without being influenced by stretching. In some implementations, the OECT device number and density for implementing the full-scale ANN algorithms can be further improved by using more expansive additive printing and photolithography methods for patterning each component in the array.

### Neuromorphic OECT Implementation of ANN

The basic OECT devices and arrays above may be adapted, expanded, constructed, and controlled for implementing practical neuromorphic computation in ANNs under different stretching conditions. Without actually building any large-scale circuits, performance of a large-scale OECT-based arrays and ANN under the various strain conditions may be simulated using the measured performance of the individual OECT devices and arrays as described, for example, in relation to Table 3 and Table 4 below. The performance of neuromorphic implementation of the various ANN algorithms may be compared to traditional non-neuromorphic implementations.

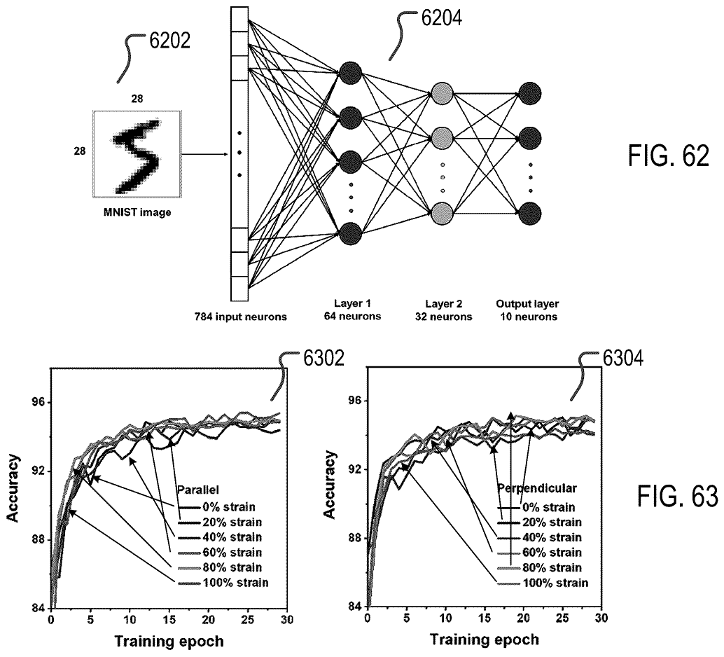

For example, the predictive accuracy and performance of a trained neuromorphic ANN model under different stretching conditions may be compared against standard AI benchmark MNIST (Modified National Institute of Standards and Technology) for hand-written digits recognition, as shown by 6202 of FIG. 62. An example 2-layer multilayer perceptron (MLP) model used for simulation is shown as 6204 in FIG. 62, containing an input layer, a 64-neuron and a 32-neuron perceptron layers, and an output layer. The simulation shows a training accuracy of >95% with a training performance that is very close to the ideal training performance with stochastic gradient descent. FIG. 63 shows the simulated accuracy of the performance of the two-layer perceptron model of FIG. 62 in recognizing hand-written digits approaching 95% under parallel (6302) and perpendicular (6304) strain of various levels as a function number of training epochs. Performance of OECT-based neuromorphic ANN of different types of algorithms for problems other than hand-written digits recognition is also simulated, showing similar predictive accuracy.

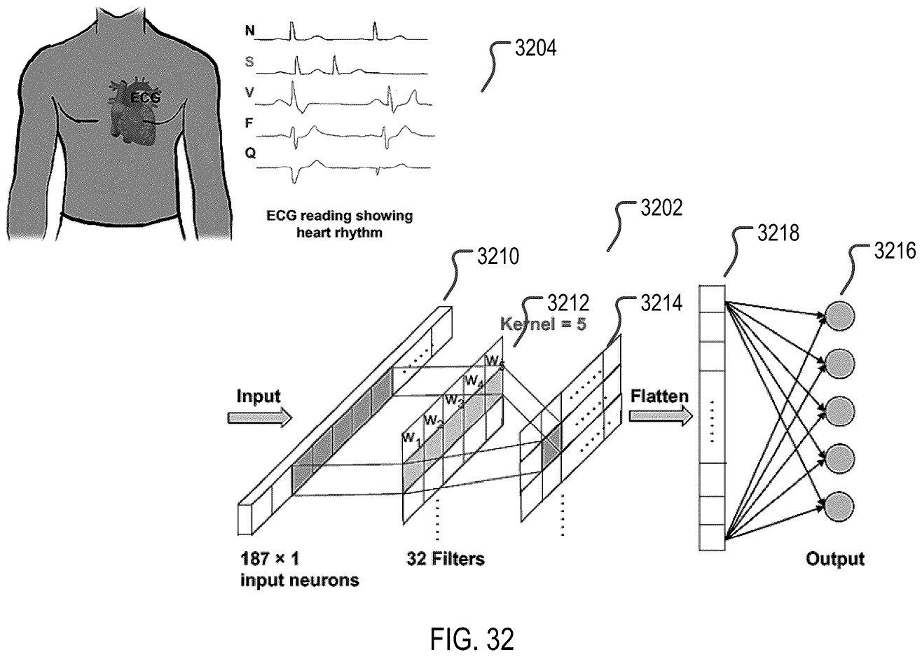

For another example, the performance of an OECT-based ANN suitable for health monitoring application may be simulated. Such example ANN may be constructed and trained to process and classify ECG data. An example of such an ANN is shown as 3202 in FIG. 32. The example ANN is trained and applied to process ECG data 3204 for classification. As shown by 3202, the example ANN may comprise a simply one-layer convolutional neural network (CNN) containing an input layer, a convolutional layer including convolutional kernels/filters 3212 to obtain feature maps 3214, and output layer 3216 (the ECG classes) connected to the flattened feature maps 3218. The input training and validation ECG data may be taken from a plurality of individuals, as shown in 3204. For example, publicly available datasets such as the Physionet's MIT-BIH Arrhythmia Dataset may be used for model training evaluation purposes. Example classes used for classifying the ECG data are shown below in Table 2 below.

TABLE 2

| Category | Annotations |
|---|---|
| N | Normal |
| | Left/Right bundle branch block |
| | Atrial escape |
| | Nodal escape |
| S | Atrial premature |
| | Aberrant atrial premature |
| | Nodal premature |
| | Supra-ventricular premature |
| V | Premature ventricular contraction |
| | Ventricular escape |
| F | Fusion of ventricular and normal |
| Q | Paced |
| | Fusion of paced and normal |
| | Unclassifiable |

For example, ECGs can be classified into normal (N) and four abnormal classes (S, V, F, Q) based on the patterns in the timing and strength of the electrical signals. A subset of balanced ECG data may be created for validation purposes. For example, 3200 training datasets and 800 testing datasets may be selected used for each of the predefined classes.

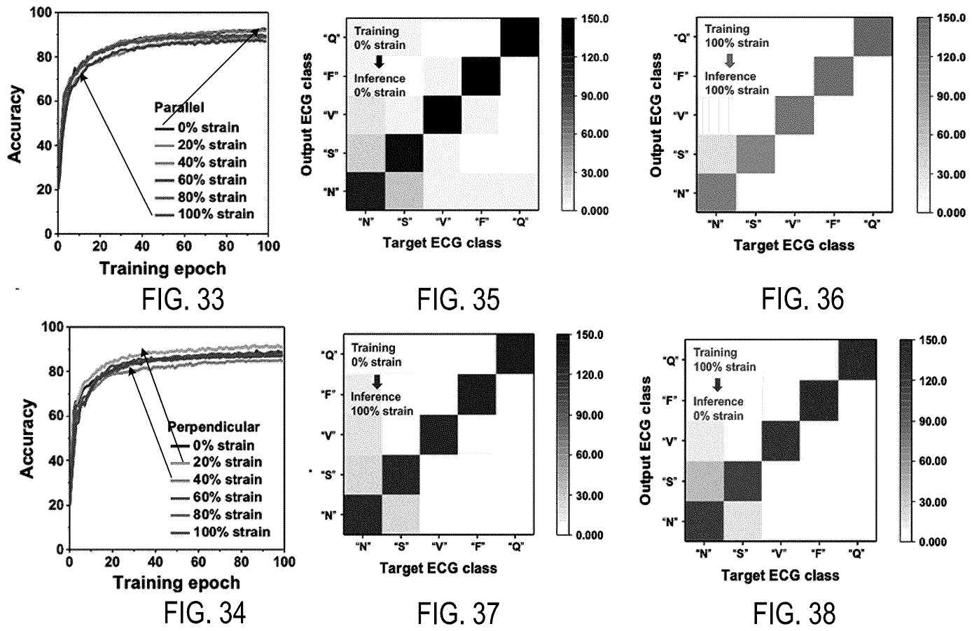

For such an example model, simulation using the OECT performance data from Tables 3 and 4 below shows that the OECT neuromorphic platform under “stretching” from 0 to 100% strain (assuming a quasi-uniform distribution of strain on the simulated chip) achieves a training accuracy that remains at ˜90% after 100 training epochs, as shown in FIGS. 33 and 34 for parallel and perpendicular strain, respectively, which illustrates the algorithmic robustness on the scaled device performance change from stretching as a function of number of training epochs. The training accuracy may be further improved by using the full dataset rather than the subset.

The effect of device stretching on inference accuracy for the ECG classification may be determined. The example 5-by-5 confusion matrixes in FIGS. 35-38 illustrate high classification accuracies on all the five classes of ECG signals. Specifically, in FIG. 35, the model is trained when the OECT ANN is at 0 strain and tested for predictive accuracy at 0 strain. In FIG. 36, the model is trained when the OECT ANN is at 100% strain and tested for predictive accuracy at 100% strain. In FIG. 37, the model is trained when the OECT ANN is at 0 strain and tested for predictive accuracy at 100% strain. In FIG. 38, the model is trained when the OECT ANN is at 100% strain and tested for predictive accuracy at 0 strain. Notably, this performance was consistently achieved whether the training and inference took place on the neuromorphic “chip” under the same or different strains. As such, the OECT neuromorphic platform above provides training and prediction performance unaffected by stretching at both the device level and algorithmic level. The neuromorphic transistors maintain high weight update linearity under different strains, and the various components of the ANN model thus processes data in a piecewise linear fashion.

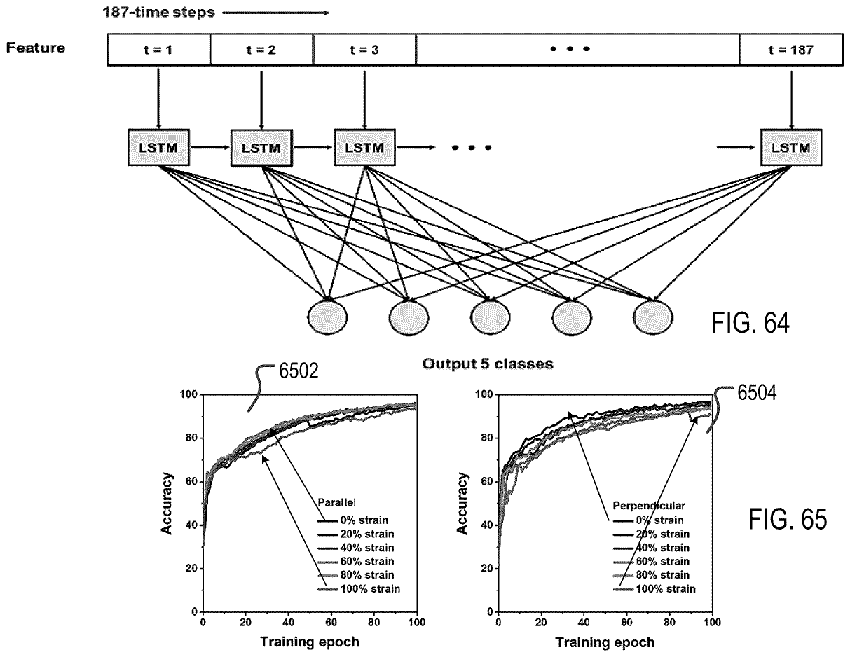

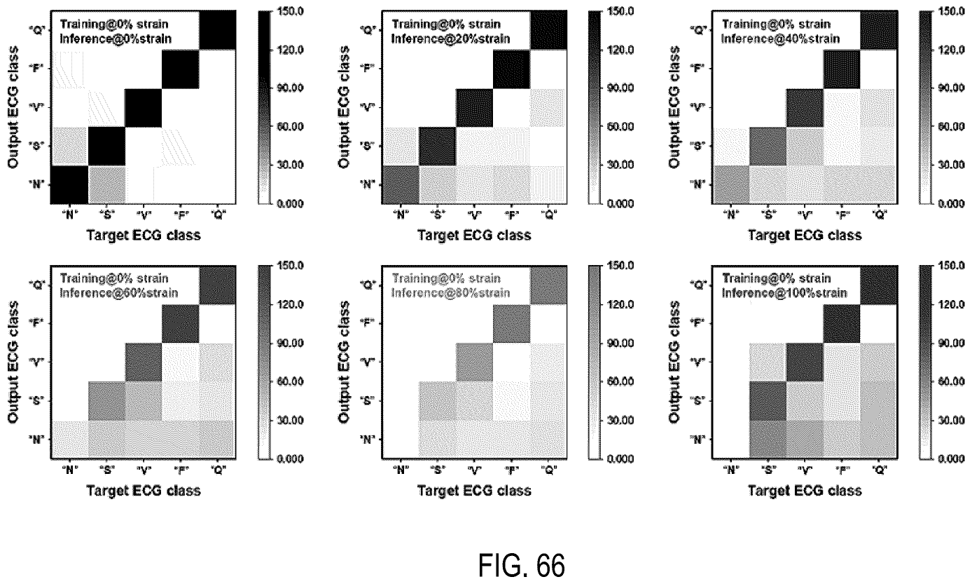

Other types of model besides the perceptron and CNN models may be further implemented using the OECT platform above. For example, a long short-term memory (LSTM) model may be implemented, which is more suitable for processing time-series signals such as ECG and other types of physiological signals. For example, an LSTM model shown in FIG. 64 may be implemented. Under static strains from 0 to 100%, LSTM as implemented in FIG. 64 may achieve higher training accuracy of ˜95%, as illustrated in FIG. 65, showing the simulated model accuracy as a function of the number of training epochs for parallel (6502) and perpendicular (6504) strain at various levels. Unlike CNN, when the strain-state difference between inference and training is greater than 20%, LSTM's inference accuracy may be observably compromised, as shown in FIG. 66. This is likely due to the use of the non-linear tanh function as a part of the LSTM's cell internaldynamics, and the recurrent nature of this architecture (whereas the CNN model above involves only linear operations).

### Example Materials and Synthesis

### Example Materials

Various materials used for synthesizing the various components of the OECT device above may include but are not limited to: polymethyl methacrylate (or PMMA, e.g., designate das 495 A6 from MicroChem Corp), (3-aminopropyl) trimethoxysilane (or APTMS, e.g., 97% concentration, from Alfa Aesar), gold (III) chloride trihydrate (or HAuCl₄, e.g., from Acros Organics), sodium borohydride (NaBH₄, 99%, e.g., from Acros Organics), trisodium citrate dihydrate (99%, from e.g., Alfa Aesar), 4-mercaptobenzoic acid (4-MBA, >95%, e.g., from TCI), L-ascorbic acid (L-AA, from, e.g., Fisher Chemical), acrylamide monomer (from, e.g., TCI), N,N′-methylene (acrylamide) (99%, from, e.g., Sigma Aldrich), ammonium persulfate (≥98%, from, e.g., Sigma Aldrich), N, N,N′ N′-tetramethylethylenediamine (TEMED, ˜99%, from, e.g., Sigma Aldrich), benzophenone (from e.g., Sigma Aldrich), silver/silver chloride (Ag/AgCl) silicone paste (from, e.g., Creative Materials), PDMS elastomer base and curing agent (e.g., Sylgard 184, from, e.g., Dow Corning), ethyl alcohol (200 proof, ≥99.5%, from, e.g., Sigma Aldrich), and trimethylchlorosilane (TMS, from, e.g., Sigma Aldrich) were used as received.

### Stretchable Hybrid Organo-hydrogel

In some example implementations, the organo-hydro-gel dielectric layer(s) may be prepared on the surface of PDMS in the following example manners. A prepared PDMS (base/curing agent: w/w=15:1) thin film may be washed thoroughly with methanol and DI (deionized) water. In some example implementations, the surface of the PDMS thin film may then be pretreated by immersing the sample in, e.g., a benzophenone solution (for example, 10 wt. % in ethanol) for ˜3 min at room temperature. After that, the PDMS thin film may be washed three times with, for example, methanol, and dried with nitrogen gas. The organo-hydro-gel may be synthesized at the surface of the benzophenone treated PDMS. For example, 1.42 g acrylamide monomer, 4.5 mg N,N′-methylene (acrylamide) cross-linker, 2.3 mg ammonium persulfate initiator, and 1.8 mg TEMED accelerator may be dissolved in 10 mL DI water. The mixed solution may be bubbled with nitrogen gas before being injected into a mold at the surface of the PDMS. In some example implementations, after the injection, the sample maybe irradiated under UV light for curing. Aftercuring, the mold may then be removed, and the synthesized hydrogel may be bonded firmly on the surfaceof PDMS. In some example implementations, the sample may be further immersed in DI water for about 24 hours, and then immersed in, for example, a glycerol/water (3:1 v/v) mixed solution (containing 0.1 M NaCl) for 24 hours to obtain the final organo-hydro-gel.

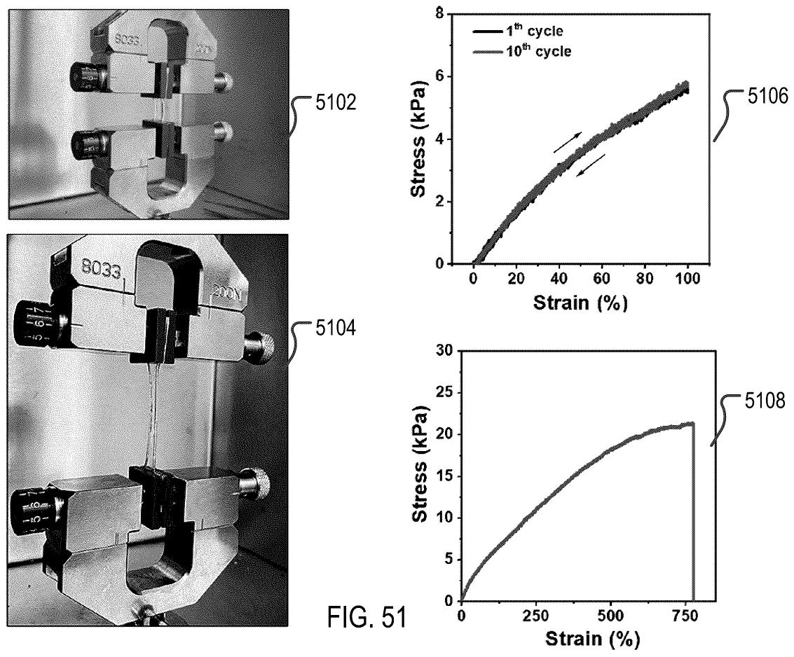

The stretchability of the hybrid organo-hydro-gel is further shown in FIG. 51, illustrating images 5102 and 5104 of example hybrid organo-hydro-gel under 0 and high stretching (600% strain). Panels 5106 and 5108 further illustrate a repeatable and consistent relationship between the strain and stress in the example hybrid organo-hydro-gel under cyclic stretching.

Redox-Active Semiconducting P (gT2)

The example redox-active semiconducting polymer p(gT2) (M_{w}=79.5 kDa, PDI=2.69) may be synthesized in various example manners. For example, 100.0 mg of (3,3′-bisalkoxy (TEG)-[2,2′-bithiophene]-5,5′-diyl) bis(trimethylstannane) (122.5 μmol) and 79.5 mg of 5,5′-dibromo-3,3′-bisalkoxy (TEG)-2,2′-bithiophene (122.5 μmol) may be dissolved in 2.0 ml of anhydrous in a dried 5.0 mL microwave vial. Degassed chlorobenzene. Pd₂(dba)₃ (2.24 mg, 2.45 μmol) and P(o-tol)₃ (2.98 mg, 9.78 μmol) may be added to the vial. The vial may be sealed under nitrogen. The vial may then be subjected to microwave heating for, e.g., 5 min at 100° C., 5 min at 140° C., 5 min at 160° C., 5 min at 80° C., 30 min at 200° C. for polymerization. In some implementations, after polymerization, the vial may be cooled, and, for example, 40 L of 2-(trimethylstannyl)-thiophene may be further added and the contents may be subjected to microwave heating, e.g., for 2 min at 100° C., 2 min at 140° C., 2 min at 160° C., 2 min at 180° C., 5 min at 200° C. Then, for example, 100 μL bromobenzene may be added and the reaction may be subjected to microwave heating, e.g., for 2 min 100° C., 2 min at 140° C., 2 min at 160° C., 2 min at 180° C., 5 min at 200° C. In some implementations, then, the reaction mixture may be cooled to room temperature and precipitated in methanol. A blue solid may be formed, which may be filtered into a glass fiber-thimble and Soxhlet extraction may be further carried out with, e.g., hexane, methanol, ethyl acetate, acetone, and chloroform for 12 h at each step. In some implementations, the polymer may be dissolved in hot chloroform. In some implementations, the chloroform solution may be concentrated and precipitated in, e.g., methanol. The collected solid may be filtered and dried under high vacuum. A blue solid may be obtained with a yield of, e.g., 84.3% (101 mg, 103.3 μmol). The reaction underlying the polymerization process are shown in FIG. 39. FIG. 40 further shows an example gel permeation chromatography (GPC) measurement performed on the polymerized p(gT2) in dimethylformamide (DMF).

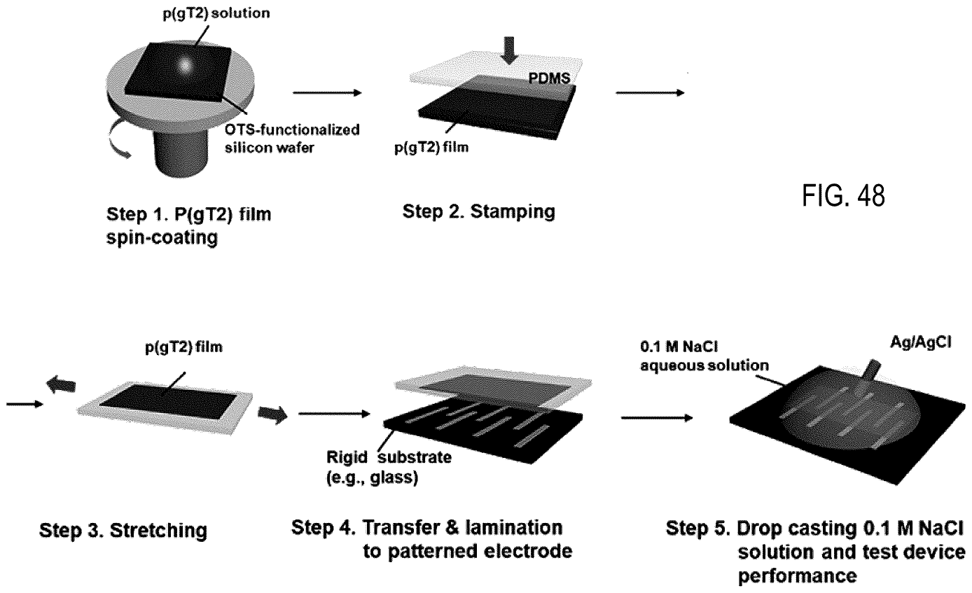

FIG. 48 shows a schematic diagram illustrating a manner in which the electric performance of the p(gT2) film under stretched conduction measured in isolation of other factors. Specifically, in step 1 of FIG. 48, the p(gT2) solution may be spin-coated on a silicon wafer. In step 2, a PMDS film may be stamped on the p(gT2) film over the silicon wafer. In step 3, the PDMS film with the p(gT2) film may then be peeled off and stretched to a desired strain level for measurements. In step 4, patterned electrodes may be transferred and laminated with the stretched p(gT2)-PDMS film. In step 5, NaCl solution at e.g., 0.1 M may be drop casted for testing the device. Various measurements performed after this preparation procedure show that the transfer curve of the p(gT2) film is minimally affected by the stretching in comparison to the pristine (unstretched) p(gT2) film.

To characterize a chain alignment due to stretching in the p(gT2) film, a polarized optical microscopy may be performed. Such a polarized optical microscopy images are shown in FIG. 54 under different strain conditions and using a polarized illumination light. The samples are rotated to different relative angles to the illumination, as indicated in the various image panels of FIG. 54. The two left panels of FIG. 54 illustrate that, without strain, the p(gT2) film image shows no dependence of rotation angle due to its isotropic morphology. However, when the strain was applied, the film displayed an observable anisotropic light transmission phenomenon that indicates the alignment of polymer chains along the strain, which results in the anisotropic charge transport capability in parallel and perpendicular directions

To further quantify a degree of chain alignment due to stretching, polarized UV-vis spectroscopy may be performed for calculating an optical dichroic ratio. It is observed that the dichroic ratio increases linearly with the applied strain, which correlates with a steady increase of chain alignment along the strain direction without signification crack propagation during stretching. Specifically, FIG. 55 illustrates polarized UV-visible spectrum measurement of p(gT2) film under different strains and a change of the dichroic ratio. The upper left panel and upper right panel illustrate the UV-visible spectrum measurement geometry for the vertically and horizontally polarized incident light, respectively. The corresponding optical absorption spectra are shown in 5502 and 5504 panels for various levels of strain. Panel 5506 shows change of dichroic ratio with the increased strain on the p(gT2) film. As described above, such dichroic ratio may be an indication of strain induced chain alignment in the p(gT2) film, underlying the observed electric response to stretching above.

To further investigate the evolution of crystalline regions under stretching that may be related to chain alignment, strained p(gT2) films may be further investigated using grazing-incidence X-ray diffraction (GIXD), as briefly described above in relation to FIG. 10. An anisotropic crystalline structure may possibly develop during the stretching, as shown in FIG. 10. FIG. 56 further shows the in-plane and out-of-plane X-ray scattering measurements of the p(gT2) film under different strain conditions. Specifically, the upper left and right panels show the X-ray beam measurement geometry in the parallel and perpendicular geometry, respectively, and the lower panels show the corresponding in-plain and out-of-plane scattering intensity under the various strain conditions. The lower panel of FIG. 56 shows that when the incident light was perpendicular to the strain direction, significant enhancements of (010) and (001) peak intensities may be observed in the in-plane direction, while in the parallel direction, these intensities decrease substantially, indicating the rotation of edge-on and end-on crystalline domains along the strain direction. Additionally, the (100) peak intensity noticeably increases in the parallel direction but almost fully diminishes in the perpendicular direction, suggesting the rotation of face-on crystalline domains along the strain direction.

As such, by combining different morphological characterization techniques in FIGS. 54-56, it may be demonstrated that the multi-scale morphological evolution may be the key reason for charge transport anisotropy int the OECT device described above in relation to FIGS. 8-10. On the other hand, the alignment of both amorphous and crystalline domains may play a central role in strain energy dissipation and crack suppression, thereby enabling good electrical performance under stretching while the anisotropy may not significantly affect the neuromorphic computing performance based on these example OECT devices and the arrays of OECT devices.

### Au-Nanowire Electrodes

The Au-nanowire electrodes described above may be synthesized over the PDMS substrate. An example procedure 4100 is shown in FIG. 41. For example, a silicon wafer (4102) may be treated with oxygen plasma. A PMMA solution (495K A6) may be spin-coated on a plasma-treated silicon wafer at a speed of, e.g., 1500 rpm, for, e.g., 60 s (4104). In some example implementations, the spin-coated sample may be baked at, for example, 180° C. for 10 mins. In some implementations, after that, a PET tape-based shadow mask may be laminated on the surface of PMMA. The unmasked portions of the PMMA may determine the areas for the Au-nanowire electrodes. In some example implementations, the sample may be then processed in plasma for several minutes (4106) and the unmasked portions of the PMMA may thus be plasma treated. Subsequently, the shadow mask may be removed, and the sample may be immersed in an absolute ethanol solution of APTMS (6 μL/mL) for, e.g., 2 h (4108). After rinsing with, e.g., ethanol, and drying in a stream of nitrogen, the sample may be immersed in gold seed solution for another ˜2 h to anchor the gold seeds on the surface of the plasma-treated area of PMMA (4110). In some example implementations, the initial Au seed solution for Au-nanowire growth may be prepared by, for example, reducing 0.25 mM HAuCl₄ with 6 mM NaBH₄ and 0.5 mM trisodium citrate dihydrate in an aqueous solution. In some example implementations, after the Au seed deposition, the sample may be washed with DI water and dried with nitrogen flow. The sample may then be immersed into an Au-nanowire growth solution (e.g., ethanol/water: v/v=1), which may contain, for example, a ligand MBA (1.1 mM), L-AA (16.4 mM), and HAuCl₄ (6.8 mM) (4112). After several minutes of growth, the samples may be rinsed with ethanol and dried naturally under ambient conditions. PDMS base and curing agent may be further mixed (w/w=15:1) and spin-coated on the sample at, e.g., 400 rpm, and after degassing, the sample may be heated at, e.g., 80° C. for several hours (4114). The PDMS may then be peeled off the silicon-PDMA wafer or the PDMA may be dissolved with, e.g., acetone, and the patterned vertical gold nanowire electrode is thus embedded in the PDMS film (4116).

The procedures and compositions above for obtaining the Au-nanowire electrodes are merely examples. Other manners in which these structures are fabricated are contemplated.

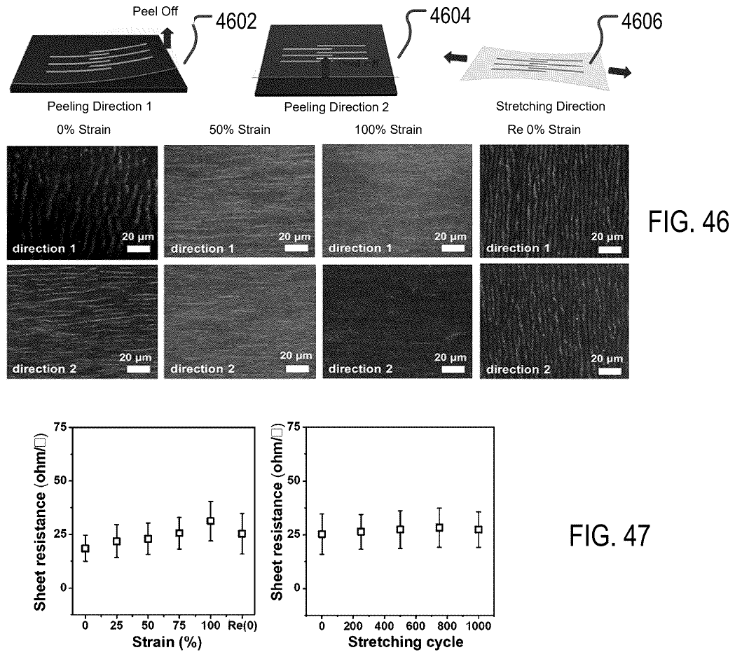

FIG. 45 shows optical images of the vertical gold nanowire electrodes on PMMA/silicon substrate fabricated with PET tape mask according to the procedure above. Optical images in the left panel (labeled as “a”) is taken before PDMS is poured whereas the optical images on the right panel (labeled as “b”) is taken after the PDMS is cured. FIG. 46 further shows optical images of the vertical gold nanowire electrodes embedded in the PDMS after being peeled off from the PMMA/silicon waver and with different applied strain. In FIGS. 46, 4602 and 4604 illustrates two different peeling directions and 4606 shows the electrodes embedded in PDMS as peeled off. The upper and lower panels of the optical images show the nanowires under different strain condition for the electrodes peeled off as shown by 4602 and 4604, respectively.

FIG. 47 further shows sheet conductance of the vertical gold nanowire electrodes embedded in PDMS as a function of stretching and as a function of repeated stretching cycles. FIG. 47 shows that the sheet resistance of the gold nanowire remains low and is minimally affected by the stretching of the electrode and remains stable after large number of stretching cycles

### Example Procedure for Fabrication of Stretchable Neuromorphic Devices

In some example implementations, the p(gT2) solution (e.g., 6 mg/mL in chloroform) may be spin-coated on octadecyltrimethoxysilane (OTS)-functionalized Si substrate at, e.g., 500 rpm for 30 s, followed by annealing at 110° C. for, e.g., 1 h in the glovebox. Stretchable Ag/AgCl paste may be blade coated onto the PDMS substrate with patterned vertical Au-nanowire electrodes. In some example implementations, after curing the Ag/AgCl paste, the sample may be plasma treated for 30 s. Then, the p(gT2) film may be transferred onto the channel area of the patterned vertical Au-nanowire electrode. In some implementations, the organo-hydro-gel/PDMS thin film described above may be laminated onto the top of the semiconductor and the gate. The packaging of the device may be fabricated by pouring the PDMSsolution (base/curing agent: w/w=15:1) on the surface of the device and curing the device at room temperature.

The procedures above for obtaining the stretchable neuromorphic devices are merely examples. Other manners in which these devices are fabricated are contemplated.

### Example Procedure for Fabrication of Neuromorphic Device Array

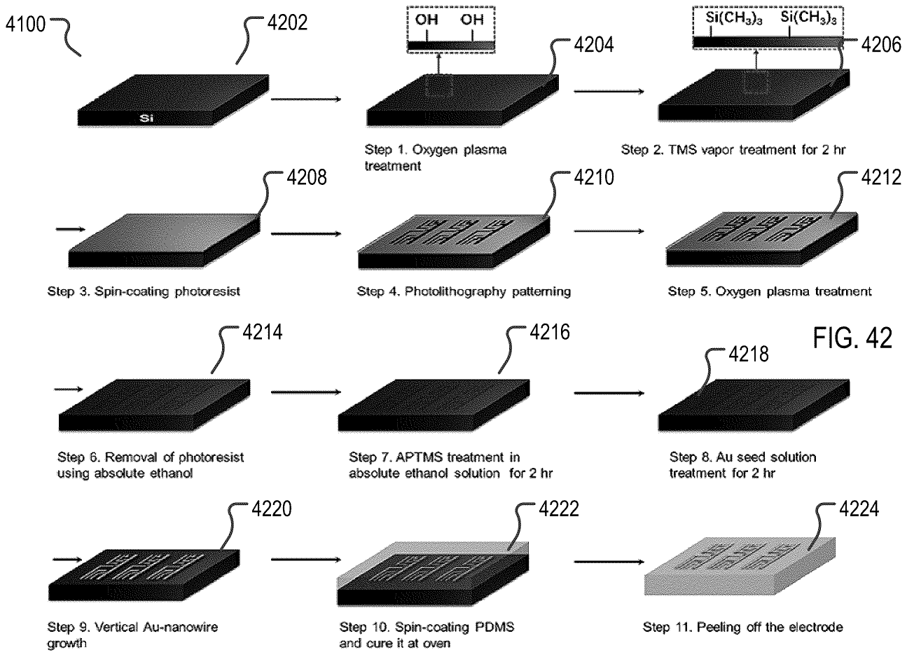

An example manufacturing process 4200 of the array of electrodes is shown FIG. 42. The silicon wafer 4202 may be treated with oxygen plasma, as shown in 4202, and placed in a container with a small vial (1-2 mL) of TMS in a fume hood. The container may then be sealed tightly, and the silicon wafer may be exposed to TMS vapor therein for, e.g., 2 h at room temperature, as shown by 4206. The sample may then be washed with, e.g., IPA and DI water followed by blow-drying with nitrogen gas. Subsequently, photo resist such as S1813 may be spin-coated on the surface of the sample at, e.g., 2000 rpm for 60 s followed by baking at, e.g., 115° C. for 60 s, as shown in 4208. Electrode patterns may be formed via a conventional photolithography process, as shown by 4210. After exposure, the sample may be immersed in developer solution for, e.g., 60 s followed by immersing it in DI water for, e.g., 60 s, as shown as part of 4210. Subsequently, the substrate may be rinsed with DI water and dried by nitrogen flow. After that, the sample may be treated with oxygen plasma for, e.g., 4 mins, as shown in 4212. Then, the photoresist may be removed by immersing the sample in, e.g., absolute ethanol solution for 5 mins, as shown by 4214. After that, the sample may be directly immersed into, e.g., the absolute ethanol solution of APTMS (6 μL/mL) for 2 h, as shown by 4216. After rinsing with, e.g., ethanol and drying in a stream of nitrogen gas, the sample may be immersed in the gold seed solution for, e.g., another 2 h, as shown in 4218. After the Au seed deposition, the sample may be washed with DI water and dried with nitrogen flow. Then, the sample may be immersed into an Au-nanowire growth solution, as shown by 4220. After several minutes of growth, the samples may be rinsed with ethanol and dried naturally under ambient conditions. PDMS base and curing agent may then be mixed (w/w=15:1) and spin-coated on the sample, as shown by 4222. After degassing, the sample may be heated, for example, at 80° C. until fully cured. The PDMS may then be peeled off the sample, and the patterned vertical gold nanowire electrodes are then embedded in the PDMS film, as shown in 4224.

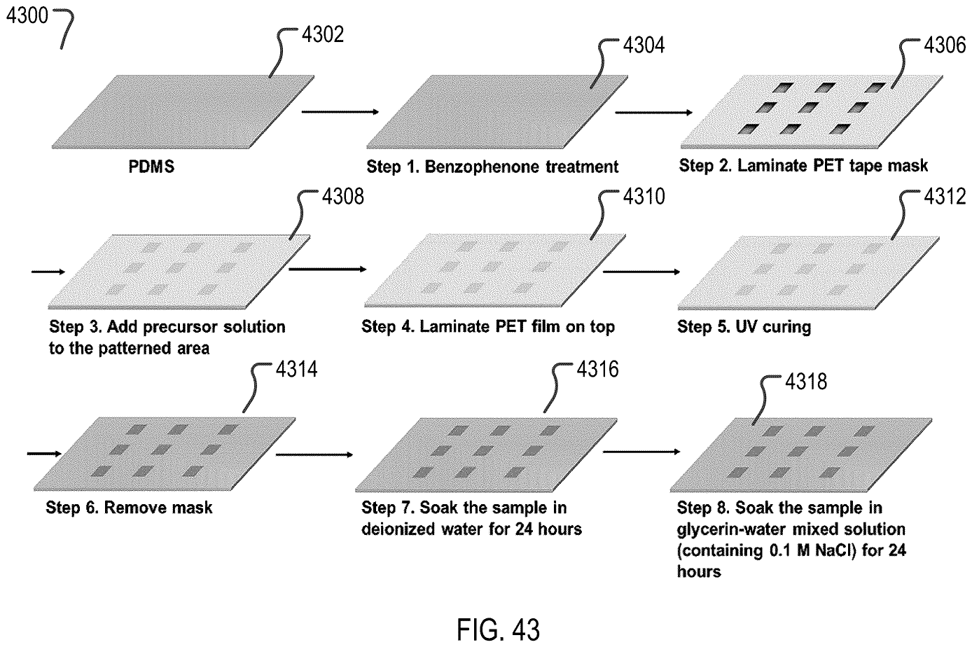

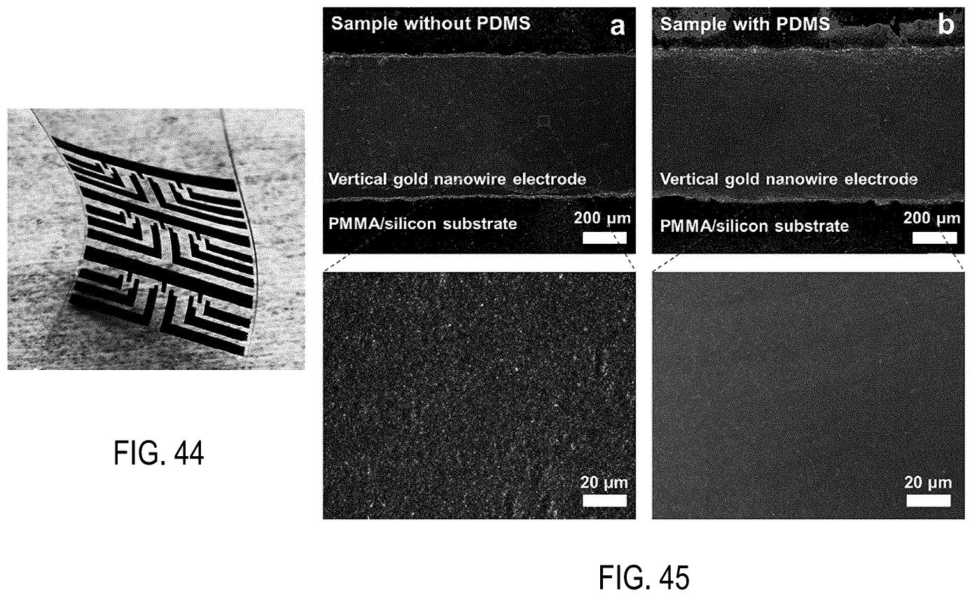

The patterned organo-hydro-gel may then be fabricated on the PDMS substrate above according to the example procedure 4300 of FIG. 43. For example, the PDMS (base/curing agent: w/w=15:1) thin film 4302 prepared as descried above may be washed thoroughly with methanol and DI water. Then, the PDMS thin film may be pretreated by immersing the sample in, e.g., a benzophenone solution (10 wt. % in ethanol) for 3 mins at room temperature, as shown by 4304. After that, the PDMS thin film may be washed, e.g., 3 times with methanol and dried with nitrogen gas. Then, a PET tape-based shadow mask may be laminated on the surface of PDMS, as shown by 4306. Organo-hydro-gel precursor solution may then be added to the patterned area, as shown by 4308, and then another PET film was laminated on top, as shown by 4310. UV curing may then be performed, as shown by 4312, and the mask may then be removed, as shown by 4314, and the sample may be soakedin DI water for 24 h, as shown by 4316. The sample may then be soaked in, e.g., a glycerol-water binary solution (containing 0.1 M NaCl) for another 24 h, as shown by 4318.

Thereafter, a p(gT2) film, as described above, may be fabricated, for example, by spin-coating p(gT2) solution (6 mg/mL in chloroform) on top of the OTS-functionalized Si wafer at 500 rpm for 30 s, followed by annealing at 110° C. for 60 min in the glovebox. After that, the p(gT2) film may be patterned through physical isolation by a razor. The device array may be fabricated by firstly blade coating the Ag/AgCl paste onto the gate area of the array electrode. Then, the Ag/AgCl paste may be cured at 80° C. for 40 mins. Subsequently, the sample may be treated with oxygen plasma for 30 s. Thereafter, PDMS may be used to transfer the patterned p(gT2) film to the channel area of the array electrode. Finally, the patterned organo-hydro-gel may be laminated on the sample to complete the fabrication of the array. An optical image of the example stretchable device array fabricated following the procedures above is shown in FIG. 44.

The procedures above for obtaining the stretchable neuromorphic device array are merely examples. Other manners in which these device arrays are fabricated are contemplated.

### Device Characterization

The basic OECT device performance described above and hereinafter may be measured using, for example, a Keithley 4200 semiconductor system. The neuromorphic performance may be measured by using, for example, two dual-channel Rigol DG 4162 function generators, a Keithley 6514 Programmable Electrometer, a National Instruments NI-DAQ, and custom-built circuits using commercial off-the-shelf components in addition to the Keithley 4200 semiconductor system. Specifically, the stretchability and the long-term storage stability tests of the neuromorphic transistors may be evaluated by using the Keithley 4200 semiconductor system. During testing, a 10 MQ resistor may be connected in series with the gate of the neuromorphic device to ensure that no unintentional loss of state occurs. The OECT devices, for example, may be tested by applying 400 consecutive potentiation pulses in-2.5 V and 200 ms duration for each potentiation pulse, followed by 400 consecutive depression pulses in 1.3 V and 200 ms duration for each depression pulse, to the gate through the resistor. Other amplitude and time duration configuration for each of the potentiation or depression pulses are contemplated. Before testing, all devices may be programmed to have a similar initial conductance. Other neuromorphic performances, including dynamic range, switching endurance, reproducibilityof conductance change, array performance as described in various sections above, may be collected by using, for example, two dual-channel Rigol DG4162 function generators, a Keithley 6514 Programmable Electrometer, a National Instruments NI-DAQ, and custom-built circuits using commercial off-the-shelf components.

### Charge Carrier Mobility, Volumetric Capacitance, and Threshold Voltage in OECT Devices

FIG. 52 shows measurements of transient responses of the OECT-type neuromorphic devices under application of a constant gate current manufactured using p(gT2) with different strain conditions. Such measurements may be used to calculate or estimate the charge-carrier mobility of p(gT2), as described below.

For example, the mobility of redox-active polymer semiconductor (e.g., p(gT2) polymer) under OECT operation may be obtained by measuring the hole transit time (Tₕ). The mobility may be calculated by measuring 10-15 channels from 3 different devices at each strain condition. Different constant gate current may be applied to the device under constant drain bias. Then the transient slope may be plotted versus gate current to calculate the Tₕ. The mobility may be calculated by:

$$μ = \frac{{L}^{2}}{{τ}_{h} \times {V}_{DS}}$$

where the μ, V_{DS}, L denote the mobility, drain voltage, channel length, respectively.

As a figure-of-merit of an OECT device, the transconductance (gₘ) for accumulation-mode devices at saturation regime may be expressed as:

$${g}_{m} = ( W / L ) \cdot d \cdot μ \cdot {C}^{⋆} \cdot ( {V}_{Th} - {V}_{G} )$$

where W, L, and d represent the channel width, length, and thickness, respectively; μ represents the charge-carrier mobility described above; C* is the capacitance per unit volume of the polymer semiconductor, and V_{Th} is the threshold voltage. To make a fair comparison between different devices, the peak gₘ may be calculated and normalized by channel geometry (W, L, and d). With the increasing strain, the normalized peak gₘ (by thickness) of the device increases when the p(gT2) film is stretched in parallel to the charge transport direction (channel direction), whereas that decreases when stretching occurs in perpendicular to the charge transport direction. To determine the main factor that impacts the normalized peak gₘ during stretching, the strain effects on V_{Th}, C*, and μ may be evaluated separately.

The volumetric capacitance may be measured by electrochemical impedances spectroscopy. For example, the strained film may be transferred onto gold substrate as a working electrode with Ag/AgCl and Pt wire as the reference electrode and counter electrode, respectively. The exposed gold may be encapsulated by epoxy resin to prevent the capacitance from gold surface. The impedance spectrum may be measured under, for example, a V_{DC} of −0.4 V and a VAC of 0.01 V with the frequency ranging from 0.1 Hz to 100 Hz. The impedance spectrum may be fit to a simplified Randle model to obtain the bulk capacitance of the film. The thickness of the film may be measured by a profilometer. As shown by the left panel of FIG. 53, the overall C* of the p(gT2) film of the device doesn't show significant changes under different strain conditions. In addition, as shown by the right panel of FIG. 53, the threshold voltage may be extracted from devices and also doesn't show significant change under strain.

In comparison, the μ follows the same trend as the normalized peak gₘ (FIG. 9 above), which is the only factor that exhibits high dependence to strain, which presumably comes from the strain-induced alignment of the polymer chains.

### Machine Learning Model Architecture

The training and inference of the example deep neural networks may be implemented using deep learning frameworks such as TensorFlow and PyTorch. The two-layer MLP model for the MNIST classification task descried above may include two hidden layers of, for example, size 64 and 32, and an output layer with, for example, size 10, consisting of 50240+2080+330=52650 weight and bias parameters. The example LSTM model described above for the ECG signal classification task may include an LSTM module and an attention head over the time dimension, consisting of, for example, 40800+9505=50305 parameters. The CNN model descried above for the ECG signal classification task may include a convolution layer with, for example, 32 filters and convolutional kernel size of 5, followed by a flatten layer, a hidden layerof size 32, and an output layer of size 5. It may thus consist of 192+187424+165=187781 parameters. All the model parameters may be trainable. For reference performance, these models were trained using standard backpropagation with the stochastic gradient descent (SGD) algorithm implemented in the deep learning frameworks.

Weight Update with Manhattan Rule

As described above, neuromorphic devices use conductance to encode model parameters. Because conductance cannot be negative, two conductance values may be needed to express the full range of a synaptic weight. For example, in an example analog training, the weights may be encoded as difference between the conductance of two devices (W=G⁺−G⁻). The synaptic weight can thus be updated by adjusting the corresponding pair of conductance states through potentiation or depression. For example, if the weight needs to be strengthened, G⁺ increases and G⁻ decreases at the same time with the application of LTP and LTD pulses on the G⁺ device and G⁻ device, respectively, thereby increasing the synaptic weight. However, unlike the SGD algorithm, the example Manhattan Rule for analog training (described in further detail below) may use the sign information for the needed weight update; the magnitude of weight change may be fixed following an update pulse. For the example neuromorphic devices above, the amount of conductance change may depend on both the device's strain state (i.e., strain) and the current conductance value. Specifically, the increase and decrease of G⁺/G⁻ may be determined by the following equations:

$${G}_{n + 1} = {G}_{n} + Δ {G}_{p} = {G}_{n} + {α}_{p} {e}^{− {β}_{p} \frac{{G}_{{n}^{−}} {G}_{m i n}}{{G}_{max} - {G}_{m i n}}} , ( {G}^{+} or {G}^{−} ↑ )$$

$${G}_{n + 1} = {G}_{n} + Δ {G}_{D} = {G}_{n} − {α}_{D} {e}^{− {β}_{D} \frac{{G}_{{max}^{−}} {G}_{n}}{{G}_{max} - {G}_{m i n}}} , ( {G}^{+} or {G}^{−} ↓ \text{)}$$

where Gₙ and Gₙ₊₁ stand for the synaptic conductance before and after the n^{th} pulse is applied, and the material parameters α and β are used to model the amount of conductance change and the nonlinearity, respectively. All the parameters in these equations including α, β, Gₘᵢₙ, Gₘₐₓ may be extracted by fitting the LTP/LTD curves measured for the OECT devices as described above. Example fitting parameters are shown below for stretching along perpendicular to and then parallel with the direction of charge transfer.

TABLE 3

| | | Potentiation | | | | Depression | | | |
|---|---|---|---|---|---|---|---|---|---|
| | | [symbol] | [symbol] | [symbol] (S) | [symbol] (S) | [symbol] | β [symbol] | [symbol] (S) | [symbol] (S) |
| Strain | 0% | 1.17E−05 | −0.0717 | 0.0019 | 0.000226 | 2.86E−05 | 1.4726 | 0.0019 | 0.00015 |
| | 20% | 1.08E−05 | [symbol] | 0.0017 | 0.000231 | 2.19E−05 | 1.1806 | 0.0017 | 0.000183 |
| | 40% | 1.11E−05 | 0.1738 | 0.0016 | 0.000234 | 1.57E−05 | 0.8062 | [symbol] | 0.000217 |
| | 60% | 9.78E−06 | 0.3104 | 0.0014 | 0.000227 | 1.35E−05 | 0.8173 | 0.0014 | 0.000179 |
| | 80% | 9.27E−06 | 0.4906 | 0.0012 | 0.000225 | 1.17E−05 | 0.8019 | 0.0012 | 0.000157 |
| | 100% | 8.96E−06 | 0.5794 | 0.0011 | 0.000228 | 9.47E−06 | 0.5746 | 0.0011 | 0.00017 |
| | Re 0% | 1.09E−05 | −0.1707 | 0.0018 | 0.000233 | 2.61E−05 | 1.3867 | 0.0018 | 0.000167 |

| | |
|---|---|
| Potentiation | Depression |

| | | [symbol] | [symbol] | [symbol] (S) | [symbol] (S) | [symbol] | β [symbol] | [symbol] (S) | [symbol] (S) |
|---|---|---|---|---|---|---|---|---|---|
| Stretching | 0 | 1.174E−05 | −0.0717 | 0.0019 | 0.00023 | 2.86E−05 | 1.4726 | 0.0019 | 0.00015 |
| eyeles | 20 | 1.035E−05 | −0.2097 | 0.0018 | 0.00023 | 2.18E−05 | 1.174 | 0.0018 | 0.00022 |
| | 40 | 1.068E−05 | −0.0577 | 0.0017 | 0.00024 | 2.27E−05 | 1.2667 | 0.0017 | 0.00018 |
| | 60 | 1.021E−05 | −0.1211 | 0.0017 | 0.00024 | 2.21E−05 | 1.2416 | 0.0017 | 0.00018 |
| | 80 | 1.054E−05 | −0.0116 | 0.0017 | 0.00024 | 2.1E−05 | 1.2065 | 0.0017 | 0.00019 |
| | 100 | 1.065E−05 | −0.0443 | 0.0017 | 0.00023 | 2.06E−05 | 1.139 | 0.0017 | 0.0002 |

[symbol]

indicates data missing or illegible when filed

TABLE 4

| | | Potentiation | | | | Depression | | | |
|---|---|---|---|---|---|---|---|---|---|
| [symbol] | | [symbol] | [symbol] | [symbol] (S) | [symbol] (S) | [symbol] | β [symbol] | [symbol] (S) | [symbol] (S) |
| Strain | 0% | 7.58E−06 | −0.1215 | 0.0019 | 0.000235 | [symbol] | 1.0002 | 0.0019 | 0.000194 |
| | 20% | 7.17E−06 | −0.0223 | 0.0017 | 0.000236 | [symbol] | 0.9071 | 0.0017 | 0.000215 |
| | 40% | [symbol] | −0.0602 | 0.0016 | 0.000235 | [symbol] | 1.0074 | 0.0017 | 0.000211 |
| | 60% | [symbol] | −0.0972 | 0.0015 | 0.000235 | [symbol] | 0.8826 | 0.0015 | 0.000206 |
| | 80% | 9.00E−06 | 0.01022 | 0.0014 | 0.000244 | 9.46E−06 | 0.9524 | 0.0014 | 0.000203 |
| | 100% | 5.80E−06 | 0.2589 | 0.0013 | 0.000228 | 7.82E−06 | 0.7427 | 0.0013 | 0.000205 |
| | Re 0% | 6.46E−06 | −0.1482 | 0.0017 | [symbol] | [symbol] | 0.9429 | 0.0017 | 0.000248 |

| | |
|---|---|
| Potentiation | Depression |

| [symbol] | | [symbol] | [symbol] | [symbol] (S) | [symbol] (S) | [symbol] | β [symbol] | [symbol] (S) | [symbol] (S) |
|---|---|---|---|---|---|---|---|---|---|
| Stretching | 0 | 7.58E−06 | −0.122 | 0.0019 | 0.000235 | [symbol] | 1.0002 | 0.0019 | 0.000194 |
| eyeles | 20 | 6.02E−06 | [symbol] | 0.0016 | 0.000263 | 0.000011 | 0.9469 | 0.0016 | 0.000222 |
| | 40 | 6.13E−06 | −0.069 | 0.0016 | 0.00026 | 1.02E−05 | 0.842 | 0.0016 | 0.000242 |
| | 60 | 6.25E−06 | −0.036 | 0.0016 | 0.00026 | 1.04E−05 | 0.8732 | 0.0016 | 0.000238 |
| | 80 | 6.13E−06 | −0.007 | 0.0016 | 0.00026 | 1.02E−05 | 0.842 | 0.0016 | 0.000242 |
| | 100 | 6.28E−06 | −0.116 | 0.0016 | 0.000264 | 1.07E−03 | 0.8664 | 0.0016 | 0.000245 |

[symbol]

indicates data missing or illegible when filed

### LTP/LTD Curve Nonlinearity and Symmetricity Analysis

As described above, the nonlinearity index (β) may be obtained by fitting the LTP/LTD curves with the following weight update formula:

$${G}_{n + 1} = {G}_{n} + Δ {G}_{n} = {G}_{n} − {α}_{p} {e}^{− {β}_{p} \frac{{G}_{{n}^{−}} {G}_{min}}{{G}_{max} - {G}_{m i n}}} ,$$

$${G}_{n + 1} = {G}_{n} + Δ {G}_{D} = {G}_{n} − {α}_{D} {e}^{− {β}_{D} \frac{{G}_{{max}^{−}} {G}_{n}}{{G}_{max} - {G}_{m i n}}} .$$

Here, Gn+1 and Gn stand for the conductance of the device when (n+1)^{th} and n^{th} pulses were applied, respectively. Gmax and Gmin represent the maximum and minimum conductance values. The parameters α and β indicate the step size of the conductance and the nonlinearity, respectively. A smaller β value corresponds to higher linearity. FIG. 57 shows calculated nonlinearities β's of the LTP and LTD behaviors ranging from 0 to 5, when the OECT device is driven by pulse numbers from 0 to n, where n corresponds to the number of pulses that give rise to max conductance G for potentiation of depression. FIG. 58 further shows measured/fitted curves in LTP and LTD regions, indicating that β (LTP/LTD)=0.214/1.227 for the measured OECT device.

The symmetricity index nay be defined as the reciprocal of the symmetric error (symmetricity index=1/symmetric error). The symmetric error may be defined as follows:

$$Symmetric errror = {\sum }_{k = 1}^{k = n} \frac{{( {G}_{N} ( k ) − {G}_{N} ( 2 n − k ) )}^{2}}{n} = {\sum }_{k = 1}^{k = n} \frac{{( G ( k ) − {G}_{m i n} ) − ( G ( 2 n − k ) − {G}_{m i n} ) )}^{2}}{n {( {G}_{m a x} − {G}_{m i n} )}^{2}} = {\sum }_{k = 1}^{k = n} \frac{{( G ( k ) − G ( 2 n − k ) )}^{2}}{n {( {G}_{m a x} − {G}_{m i n} )}^{2}} , \text{} where {G}_{N} ( k ) = \frac{G ( k ) − {G}_{m i n}}{{G}_{m a x} − {G}_{m i n}}$$

Here, Here, G_{N}, Gₘₐₓ, and Gₘᵢₙ represent the normalized value of the conductance, themaximum value of the conductance, and the minimum value of the conductance, respectively. FIG. 59 illustrates completely asymmetric (symmetricity index=0) and symmetric (symmetricity index=∞) conductance curve for an LTP and LTD cycle as a function of the number pulses. FIG. 60 shows measured LTP/LTD curves with 800 conductance states (400 states in LTP and 400 states in LTD) and the k^{th} conduction state in LTP and (800-k)^{th} conduction date in LTD. The discrepancy of the two states in conductance indicates the asymmetry. Essentially, the kt and the (800-k)^{th} conduction states are both pulled from the corresponding points on the complete symmetric curve towards the asymmetric curve of FIG. 59. conductance is pulled. The amount of such pull may be used to quantify the asymmetry of the curve.
Weight Update with Cumulative Manhattan Rule

Manhattan Rule is a weaker version of the backpropagation algorithm in that it only uses the sign of the gradient. As such, it may be ineffective at dealing with situations where the amount of update needed differs substantially among all the parameters in a network. In some implementations, to combat this problem, a variation of the Manhattan Rule, referred to as Cumulative Manhattan Rule in this disclosure, may be used to simulate the training of the neural network. In such implementations, the resolution of weight updates may be improved by accumulating gradients across batches. For example, the sign of the sum of all gradients during the current training period may be used. Whereas the original Manhattan algorithm discards magnitude between batches, these improved implementations preserve this information. For example, if a large positive gradient is followed by many small negative ones, the original Manhattan method would apply more negative changes, resulting in an overall update in the wrong direction. The improved implementation, in contrast, would keep the right direction by tracking the aggregated gradients. Simulation results show that such improved implementations generally converge faster and achieve better performance on all the models being experimented with. The simulation results above and hereinafter are obtained based on Cumulative Manhattan Rule.

### Simulation of the Strain Impact on Machine Learning

Under different strain conditions, the device conductance responds to pulses differently. This relationship may be modeled by the equations in the previous section on weight updates. By subjecting the material to a wide range of strain conditions and recording the pulse response curves, the parameters α, β, Gₘᵢₙ, Gₘₐₓ for each strain condition may be extracted and stored in a lookup Tables 3 and 4 as shown above. Thus, to simulate the impact of a constant strain, the parameters may be looked up from these tables and the conductance updates may then be applied accordingly in the simulation of model training. If the strain changes, all weights would be affected. The new conductance value may be obtained by scaling the original value by a constant factor, which is roughly estimated from the difference in transfer curve as measured under different strains. The scaling factor between two strain conditions may be derived, for example, by averaging the ratio of experimentally recorded conductance values in the same range.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” or “in some embodiments/implementations” as used herein does not necessarily refer to the same embodiment and the phrase “in another embodiment/implementation” or “in other embodiments/implementations” as used herein does not necessarily refer to a different embodiment/implementation. It is intended, for example, that claimed subject matter may include combinations of example embodiments/implementations in whole or in part.

In general, terminology may be understood at least in part from usage in context. For example, terms, such as “and”, “or”, or “and/or,” as used herein may include a variety of meanings that may depend at least in part upon the context in which such terms are used. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

1. A wearable device: comprising
a stretchable substrate;
a stretchable capping layer; and
a stretchable artificial neural network (ANN) circuitry integrated between the stretchable substrate and the stretchable capping layer, the ANN circuitry comprising interconnecting artificial neurons, wherein each artificial neuron comprises at least one stretchable organo-electrochemical transistor (OECT) and each OECT comprises:
a gate electrode;
a semiconducting layer, the semiconducting layer being redox-active;
a source electrode and a drain electrode in electrical contact with the semiconducting layer;
a dielectric layer disposed between the gate electrode and the semiconducting layer, the dielectric layer being of an electrolyte-type; and
an electrical channel through the semiconducting layer from the source electrode to the drain electrode, the electrical channel being characterized by a plurality of conductance states to enable neuromorphic computation in the ANN circuitry;
wherein the gate electrode, the semiconducting layer, the source electrode, the drain electrode, and the dielectric layer are stretchable.

2. The wearable device of claim 1, wherein the semiconducting layer comprises a redox-active polymer.

3. The wearable device of claim 2, wherein the redox-active polymer comprises polythiophene backbone and tri-ethylene-glycol (TEG) side chains.

4. The wearable device of claim 2, wherein a conductance state of the electrical channel among the plurality of conductance states is controlled by an electrical signal applied to the gate electrode.

5. The wearable device of claim 4, wherein the electrical signal controls the conductance state of the electrical channel by modifying a carrier doping in the semiconducting layer via an ion-transport pathway through the dielectric layer of the electrolyte-type.

6. The wearable device of claim 5, wherein the electrical channel is potentiated to a higher conductance state under the electrical signal on the gate electrode of a first polarity relative to the source electrode, whereas the electrical channel is depressed to a lower conductance state under the electrical signal on the gate electrode of a second polarity relative to the source electrode opposite to the first polarity.

7. The wearable device of claim 4, wherein the electrical signal comprises one or more electrical pulses each having a pulse area and each electrical pulse potentiate or depress the electrical channel according to the pulse area, the pulse area being an amplitude of the each electrical pulse being time-integrated over a duration of the each electrical pulse.

8. The wearable device of claim 1, wherein the stretchable substrate and the stretchable capping layer comprise polydimethylsiloxane (PDMS) and the stretchable capping layer.

9. The wearable device of claim 1, wherein the source electrode and the drain electrode comprise an array of conducting nanowires dispersed in a stretchable host.

10.-12. (canceled)

13. The wearable device of claim 1, wherein the gate electrode comprises a stretchable redox-active electrode.

14. (canceled)

15. The wearable device of claim 1, wherein the dielectric layer comprises a hybrid organo-hydro-gel based on a polyacrylamide (PAAm) network swelled by a water-glycerol binary solvent.

16. (canceled)

17. The wearable device of claim 15, wherein the hybrid organo-hydro-gel further comprises water-solvated salt that penetrates the semiconducting layer to dope the semiconducting layer.

18. (canceled)

19. The wearable device of claim 1, wherein one or more stretchable OECTs are configured to store a weight parameter of the ANN circuitry.

20. The wearable device of claim 19, wherein weight parameters of the ANN circuitry are written into the at least one stretchable OECTs by potentiation and/or depression electrical signals applied between the gate electrode and the source electrode.

21. The wearable device of claim 20, wherein two OECTs corroborate to store one weight parameter.

22. The wearable device of claim 20, wherein a training process of the ANN circuitry comprises a sequence of writing operations to update the weight parameters using the potentiation and/or depression electrical signals.

23. The wearable device of claim 1, wherein an OECT of the at least one OECT is configured to maintains its conductance state for at least 1000 seconds in an absence of a voltage applied between the gate electrode and the source electrode.

24. The wearable device of claim 1, wherein the ANN circuitry is configured to perform vector-matrix-multiplication of input signal with ANN weight parameters stored in the ANN circuitry.

25. The wearable device of claim 1, wherein the wearable device is adapted to conformally adhere to human skin.

26. A wearable device: comprising
a stretchable substrate;
a stretchable capping layer; and
a stretchable artificial neural network (ANN) circuitry integrated between the stretchable substrate and the stretchable capping layer, the stretchable ANN circuitry comprising interconnecting artificial neurons comprising organo-electrochemical cells,
wherein the stretchable ANN circuitry is configured to implement a neuromorphic artificial intelligence computing algorithm.
